(19) United States
(12) Patent Application Publication
(10) Pub. No.: US 2006/0150218 A1
(43) Pub. Date: Jul. 6, 2006

(54) System for buying goods and services

(76) Inventors: Clifford Warren Lazar, Los Angeles, CA (US); Paul M. Meadows, Glendale, CA (US)

Correspondence Address: Clifford W. Lazar, 9717 Cisco Street, Los Angeles, CA, 90034-1053, US

(21) Appl. No.: 11/325,938

(22) Filed: Dec. 30, 2005

Related U.S. Application Data
(60) Provisional application No. 60/641,312, filed on Jan. 3, 2005.

(51) Int. Cl. G06F 17/30; H04N 5/445; G06F 3/00

(52) U.S. Cl. 725/60; 705/26; 705/27

(57) ABSTRACT

A method and system to add functionality to digital video recorders (DVRs). In its various embodiments the present system has multiple functions: Increase response to TV commercials and product placements; selection of the power-on station thus benefiting a network or networks and/or a major marketer, Utilizing the infrastructure of the DVR and DVR hand-held remote to facilitate user response to commercials and product placements on DVD's other non-broadcast electronically transferred content, including but not limited to downloaded shows and movies, print ads, catalogs and other indicators of available products, enhancing interaction with vendor/advertisers. The present invention works with digital video recorders and other devices that process and pass real-time television broadcasts, delayed replays of broadcasts, recorded broadcasts, non-broadcast electronically transferred content and DVD's to television monitors.

### CROSS-REFERENCE TO RELATED APPLICATIONS

U.S. Pat. No. 6,477,508 by Lazar et al. issued Nov. 5, 2002, PROVISIONAL PATENT APPLICATION: 60/641,312, by Lazar et al. filed Jan. 3, 2005

This application claims the benefit of provisional patent application: 60/641,312, by Lazar et al. filed Jan. 3, 2005. U.S. Pat. No. 6,477,508 by Lazar et al. issued Nov. 5, 2002 is incorporated by reference.

### SEQUENCE LISTING OR PROGRAM

Not Applicable

### FIELD OF THE INVENTION

The field of the invention pertains to methods of facilitating sales of products and services advertised in TV commercials, on DVD's, and other non-broadcast electronically transferred content, and in print advertising. Additionally, the field includes any form of written media wherein advertisements may include identifying codes that may be used to facilitate connecting readers with vendors. Further, the present invention ensures that a sponsoring network or a sponsoring advertiser will be the power-on channel, thus enhancing the opportunity to deliver millions more commercial views. The present invention assumes the existence of one or more designs of digital video recorders, such as TiVo and Viiv memory based entertainment devices, and teaches modification of the software and memory allocation of said DVR's and memory based entertainment devices to facilitate sales of products and services and exposure of sponsoring network and/or advertiser commercials and/or product placements.

### BACKGROUND

The Dec. 25, 2004, Los Angeles Times reported that viewers, using digital video recorders, are skipping past 30 second commercials which are the prime source of income to television and cable networks, making the rare exposure of commercials to viewers extremely valuable. Any technology or method, which can make the occasion when a viewer is actually interested in the product being pitched in a commercial, more effective, adds value to the broadcaster and content delivery service. In its various embodiments the present system facilitates viewer response to ads and/or product placements. It is obvious that the viewers, who respond to advertisements, using the various embodiments the present system system, are already interested in the purchase of the item of interest, providing a far better situation than for an advertiser trying to make a cold call to a potentially interested consumer who may become antagonistic if interrupted. Allowing the viewer to contact the sponsoring vendors simply by pressing a designated buy button on the DVR remote will substantially increase the effectiveness of commercials and product placements. This designated buy button may be any button not being used during a live or pre-recorded show. It will be used as the designated buy button. Another button will be used as the designated capture button. This allows the inventive system to use the existing infrastructure of TiVo and/or other DVR or entertainment devices without the need to replace the hardware.

TiVo, the leading digital video recorder (DVR) company, has not yet become profitable, in part because cable operators such as Cox and Time Warner are offering their own digital video recorders and, in its negotiations with Comcast, TiVo ceded the lion's share of the subscription fee to Comcast in their proposed merger of services. Meanwhile many other companies are providing electronic entertainment devices, such as Intel's Viiv that will allow storage of an entertainment stream using some form of memory.

In its various embodiments the present system will increase the effectiveness of television commercials and product placements and create a new revenue source for a DVR company such as TiVo, a provider of entertainment content, a cable operator, or broadcast networks that want the huge advantage of being the power-on station, i.e., every time the viewer powers on the TV, the station that is displayed belongs to the network that pays the host company. We refer to this as the power-on station. The host company can be the DVR operator or a third party.

The power-on station can be variable, in that it can be whatever station carries a commercial or product placement from a major advertiser such as General Motors or Procter and Gamble. In its various embodiments the present system would allow the major advertiser to enjoy more total responses from viewers from a smaller commercial budget.

An additional capability of the system is to allow users of the DVR or an entertainment device to capture numbers displayed in a print ad, a catalog or on a device via the remote keyboard and then press a designated buy button to be put in contact with the vendor/advertiser. This capability will substantially increase the response rate to print advertising due to the ease of the DVR link.

A designated buy button can be any button on a remote that would not cause an action in the DVR in the context when it is pushed. In the Case of the TiVo remote such a designated buy button could be “Window” button or the Thumbs Up button. A sticker affixed to the remote would indicate the designation.

Most DVD's and electronically transferred content (ETC) carry movies and TV shows, some with embedded product placements. DVD's and ETC's commonly have trailers for other movies and DVD's. Some DVD's and ETC's have commercials for products and services. Examples of this are the James Bond movies that have such product placements as the BMW Roadster and the Omega Watch. The products embedded in these movies become prompts to the viewer, who may click a designated buy button to be put in contact with the vendor. The movie trailers that may be present on these DVDs become sales prompts as well, so that movies advertised on the said DVD may be sold to the viewer as well, just by clicking a designated buy button. The present invention teaches alternative methods to capture needed DVD or ETC identification and product identification in order to arrange communication between the viewer and the appropriate vendor.

Many examples of prior art depend upon modifications to the hand-held remotes. Since there are nearly 100 million hand-held remotes in use, replacing them or supplementing them with modified remotes would cost in excess of hundreds of millions of dollars, with no guarantee of their use. In its various embodiments the present system relies instead on a very low cost modification of the software in viewers' DVR's to achieve the ability to facilitate viewer contact with vendors and vendor access to viewers.

For the purpose of providing a clear and concise description of the technology of the invention certain assumptions will be made throughout this summary:

When communication from the digital video recorder system (DVR) and/or entertainment center to a host computer or between a host computer and a vendor computer is described it shall be assumed that any applicable communication technology currently available or which may be available in the future may be utilized. Bi-directional communication channels which may be employed to transfer data between system entities may include but are not limited to telephone modem (land or cellular/wireless), cable modem, DSL, WiFi, fiber-optic modem, satellite modem, either direct-connection, gateway mediated or internet protocols are all valid examples;

Communication between the remote control (RC) and the DVR may be mediated through, at least, traditional infrared (IR) means or by radio-frequency (RF) means. Examples of RF are Bluetooth or Zigbee, IEEE 802, wireless/cordless telephony and cellular telephony.

Product and vendor identifications in print ads, catalogs and on devices may follow and allow industry standards and new or abbreviated standards or may use a proprietary method. Examples are UPC codes as can be seen associated with bar codes on products or codes that are employed to support products sold at traditional point of sale (POS) merchants using optical scanning methods or direct key entry of product code information; Memory storage may be assumed to be hard-disk, solid state memory, internal or external, or any format, which may be readily available or applicable to the uses described herein.

The use of an RF technology, such as Bluetooth, Zigbee, or other wireless technology in addition to the traditional infrared methods, could enable the transfer of information from the remote control to the DVR or entertainment center (DVR/EC) as long as the hand-held remote is within range of the DVR, thus instantaneous transactions may still take place using the Buy button, even though the user is not in the same room as the DVR.

When the communication channel is limited, e.g. to phone line and modem, it is also possible to program at what time the DVR transfers data to the host so that the viewer phone line or other communication channel is not unduly occupied or that data transfers are not occurring at any time that phone might otherwise be used by the viewer, e.g. a time slot of 3:00 AM to 5:00 AM might be used for data transfers because this time slot is not likely to be used by the viewer for phone calls;

It shall be assumed that TV channels shall range from 1 to 999 and thus are only up to 3 digits in length. Future expansion of the channel range is certainly possible, and adjustments to the descriptions given here would need to be made to accommodate this expansion.

### OBJECTS

In its various embodiments it is the object of the inventive system to: (a) Facilitate and increase viewer response to TV commercials and product placements; (b) Select the power-on station depending upon whether a network or a major marketer pays for the system power-on service; (c) Utilize the infrastructure of the DVR and the DVR hand-held remote to facilitate the user response to commercials and product placements on DVD's; (d) Utilize the infrastructure of the DVR and the DVR hand-held remote to facilitate the user response to commercials and product placements on other non-broadcast electronically transferred content (ETC) including but not limited to downloaded shows and movies; (e) Utilize the infrastructure of the DVR and the DVR hand-held remote to facilitate the user response to print ads, catalogs and other indicators of available products, enhancing interaction with the vendor/advertisers, including after market sales of consumable and replacement items used in devices.

### SUMMARY OF THE INVENTION

Date-Time, Channel and City uniquely identify commercials and product placements in radio and television broadcasts. Sponsors buy time slots on networks and from local broadcasters. In the case of digital video recorders (DVR), the display date-time may be different from the scheduled broadcast date-time. When TV shows are recorded on a DVR, the original broadcast date-time and Channel are recorded with the program sound and picture in a file in the DVR's memory. In addition, the DVR has a description of the user/viewer, including city and phone number. When the viewer begins playing a recorded TV show, the DVR maintains the current elapsed viewing time in a memory location. When the viewer clicks the DVR's remote designated buy button to purchase a product or service, the elapsed time is captured and added to the original broadcast start date-time to yield the time of the commercial or product placement as if the show was being watched as originally scheduled. We call this the date-time per schedule (DTPS). The DTPS, along with the channel and city, the viewer information and the message type are assembled into the message string buffer and the entire record is passed over the communication line to the Host computer.

The Host computer receives the record, separates out the various components described above and searches its database using commercial or product placement date-time per schedule (DTPS), Channel and City to determine the product ID, vendor and the vendor phone number, Internet address (URL), email address or other contact method. The Host computer then contacts the vendor who then contacts the viewer to finalize the details of the sale such as but not limited to price, quantity, size, color, and credit card information. It is possible for frequent buyers to have arrangements with vendors such that accelerated methods for sales may be put into place for reduced effort on the part of the vendor and greater ease of use for the viewer.

The Host computer may update the DVR's program schedule from time to time and it may also update the power-on channel and date-time table. If there is only one sponsor channel, then only one power-on channel is updated. If a major marketer sponsors the system, then a plurality of date-times and channels are updated. These coincide with the date-times and channels of the major marketer's commercials or product placements and would be used for the power-on channel during the time slot sold to the sponsor. It is possible to have multiple networks or multiple marketing sponsors.

In an alternative mode the DVR may engage in Channel switching to follow a sponsor, after the TV has already been turned on and a show has been viewed to the end of the show, when another sponsor time segment begins. This would allow smooth transitions from one program channel to another without interruption of program content. If the DVR has been programmed by the viewer/user to switch to a different program, the wishes of the user will be followed. For instance, in the case when a sponsor has sequential time slots, but on different channels the DVR would transition from the first channel to the second channel at the conclusion of the first sponsor program such that the viewer would not be unduly aware of any changes in the channels. Because this particular feature may be considered annoying by some viewers, it can be enabled or disabled by the host, dependent upon agreement terms with sponsors of advertisements and product placements or by the viewer's choice. This function can also allow for automatic channel switching where there are two or more sponsors.

The present invention will allow a user, who is reading a print publication (or radio or other format for that matter), to easily capture the identity of a print ad and make contact with a vendor/advertiser via the DVR. A means to differentiate a television station channel from the number associated with a print advertisement is necessary. With most television station channel selection methods, when the user wishes to select a television channel they may enter one to three digits on the remote control and after a brief pause the channel is selected.

The present invent requires the viewer to press a Capture button, followed by one to six digits on the keypad, followed by the designated buy button. If the viewer fails to press the designated buy button within a specified time period the buffer is flushed.

It could also be assumed that if the remote is not in television viewing mode (i.e. TV power has not been applied and no other functions have been used for a long period of time) that the use of digit keys is meant to be a print ad number and not a TV channel. It is still required that the viewer presses the designated buy button.

Advertisement identification numbers from one to three digits could be facilitated by immediately following (i.e., virtually no delay between key presses) the identification number entry by previously pressing the designated buy button. This would allow these premium, high speed and simple identifications to be provided to major advertisers who are willing to pay a premium for these exclusive and limited identification numbers. Tiered pricing of the digits 0-9 would be the most expensive, followed by the numbers 10-99, and then by 100-999, and so forth. Obviously the fewer the digits in an advertiser's product identification number, the easier it will be for a viewer to key it in to contact the vendor.

Pressing another button for another function, e.g. the volume up button may be used to escape from the digit entry process. If a display were present on the remote control, the alternate function would clear the display. If an LED indicated a product advertisement identification number operation pressing the alternate key function would clear the LED. Keys may be additionally added to the remote control to facilitate editing of entries, e.g. a backspace key, delete key, arrow key, or other key function to work in like manner.

The hand-held remote could also capture standard product codes, for instance, 12 or more digits comprised in a standard UPC code product identification. As long as the user presses the Capture button a channel will not be selected and it will be assumed that a print ad identification number is being entered. The remote may have an LED or other display feature to indicate that it is in the print ad mode. A display that indicates numbers may additionally be used by the user to verify the accuracy of the digits entered. While this particular method would be somewhat cumbersome, it could allow a much larger number of advertisers to be able to participate with the marketing advantage that this method brings to the market. It could even be useful to gauge the market interest in a product before a relationship with a vendor is established. For instance, if a viewer enters a UPC number for a product that has not been registered with the DVR company, the interest of the viewer is logged by the host computer, and if sufficient numbers of viewers show an interest in that product then a marketing relationship could be promoted to the vendor by the DVR company. Meanwhile the viewer could be put in contact with a vendor of a similar product or the vendor of the actual product in a show of effectiveness to the prospective vendor.

Alternatively, the hand-held remote may include a bar code reader to capture standard bar codes. When a barcode is captured and followed by the viewer pressing the designated buy button 36 a transaction would be initiated.

The invention will facilitate the service and ordering of parts for many types of products. Examples of products that may benefit from this would be household appliances, home entertainment systems, automobiles and the like. Industrial and commercial equipment could similarly be managed with this system. For example, if a consumer needed to order a front panel for a microwave the barcode of the microwave could be scanned from the owners manual or the microwave itself and the front panel could be ordered when the manufacturer or its representative or distributor contacts the customer. Scan codes could even be provided for parts of the microwave or service items may be ordered in a likewise manner by having barcodes assigned to those services in the owner's manual. For the commercial or industrial environment the invention could take the form of a remote hand held terminal that links to a centrally located controller to communicate with the host computer and vendors.

### BRIEF DESCRIPTION OF THE DRAWINGS

FIG. 1 displays an overview of the components of the system; The system is composed of four major subsystems: a) Hand-held universal remote, b) DVR, c) Host Computer, d) Vendor computer(s).

FIG. 2A displays an overview of the components involved in print ad handling.

FIG. 2B displays a processing print ad designated capture key event

FIG. 2C displays processing print ad number capture.

FIG. 2D displays processing print ad buy event.

FIG. 3 displays three modes of DVD connection to the DVR

FIG. 4 an overview, displays the components involved in processing a viewer response to a DVD through the DVR including the remote, the DVR, the host, and vendor computers.

FIG. 5A Flowchart-Overview of DVD Events Handling FIG. 5B Flowchart displays the steps to finding unique pixel pattern for DVD-capture N pictures.

FIG. 5C Flowchart displays the steps to finding unique pixel pattern for DVD-N Pixel Matrices

FIG. 5D Flowchart displays the steps to finding unique pixel pattern for DVD-result matrix

FIG. 5E Flowchart displays the steps to DVD play started

FIG. 5F Flowchart displays the steps to handling designated buy key event for DVD

FIG. 6 Flowchart displays the steps to ad number signal determination

FIG. 7A Overview of Host DVD Handling

FIG. 7B Flowchart displays the steps to host finding unique pixel pattern for DVD-Capture N Pictures

FIG. 7C Flowchart displays the steps to host finding unique pixel pattern for DVD-N Pixel Matrices

FIG. 7D FIG. 7D Flowchart displays the steps to Host Finding Unique Pixel Pattern for DVD-Result Matrix

FIG. 7E Flowchart Finding Unique Pixel Pattern for DVD-Result Matrix—Host Version

FIG. 7F removed

FIG. 7G Flowchart displays the steps to host DVD order processing

FIG. 7H Packet Type Processing

FIG. 8A displays and overview of the system components used to handle electronically transferred content (ETC) and provide the ability to process buy requests from the viewer.

FIG. 8B Host ETC Order Processing

### DETAILED DESCRIPTION

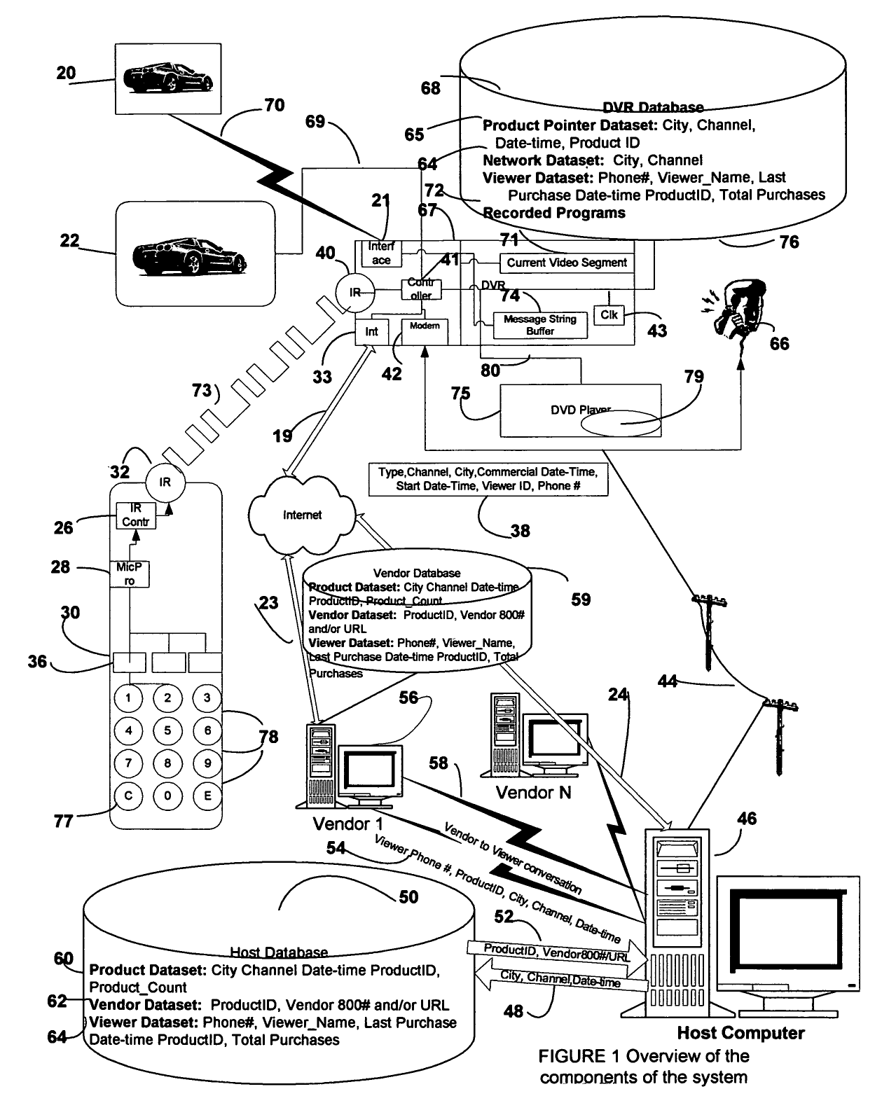

FIG. 1 displays an overview of the components of the system. The system is composed of four major subsystems: a) Hand-held universal remote 30 with infrared transmitter 32 and designated buy button 36; b) DVR 67 with DVR database 68 and modem 42 (to connect via the public telephone system to Host Computer or via the Internet 19), and; c) Host Computer 46 with Host database 50; d) Vendor computer(s) 56 with modem 54 (to connect via the public telephone system to Host Computer or via the Internet 24) and Vendor database 59. Items (c) and (d) are linked via telephone lines 44 or Internet or any other means known to the art allowing data transfer between independent elements.

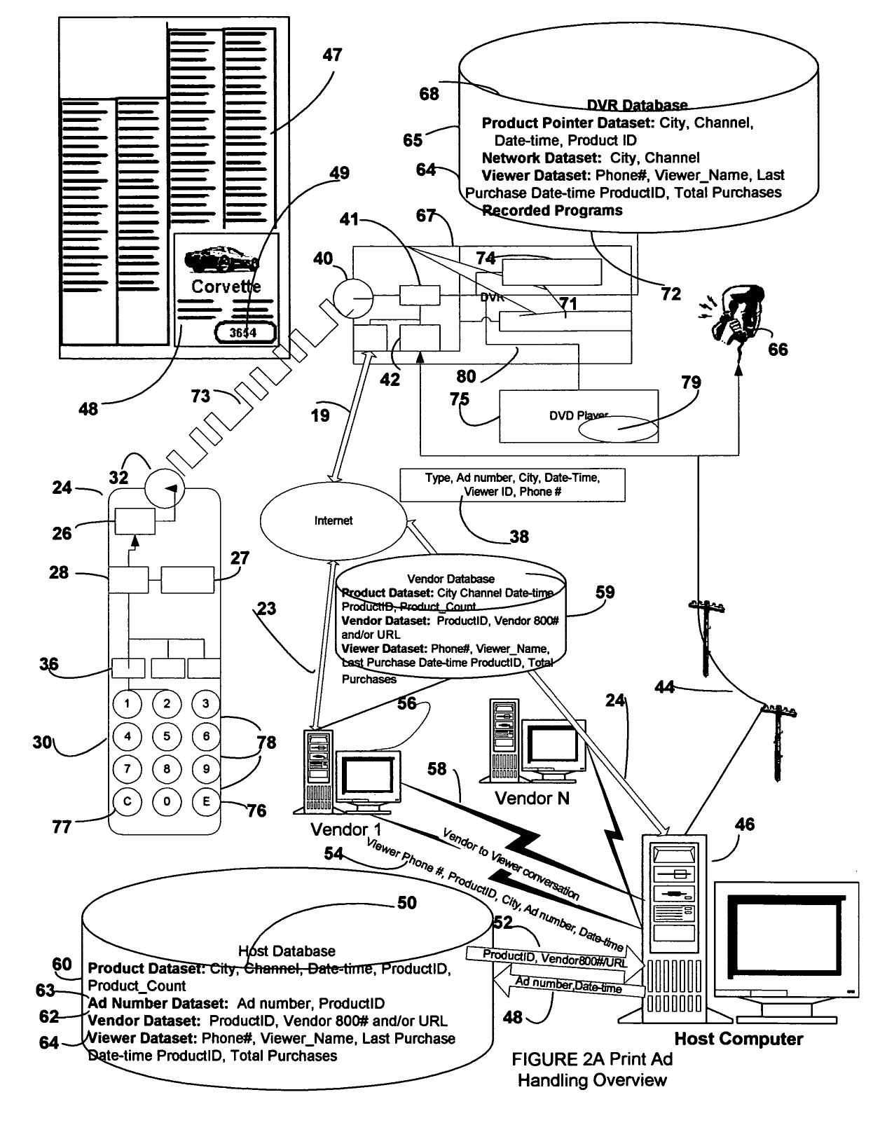

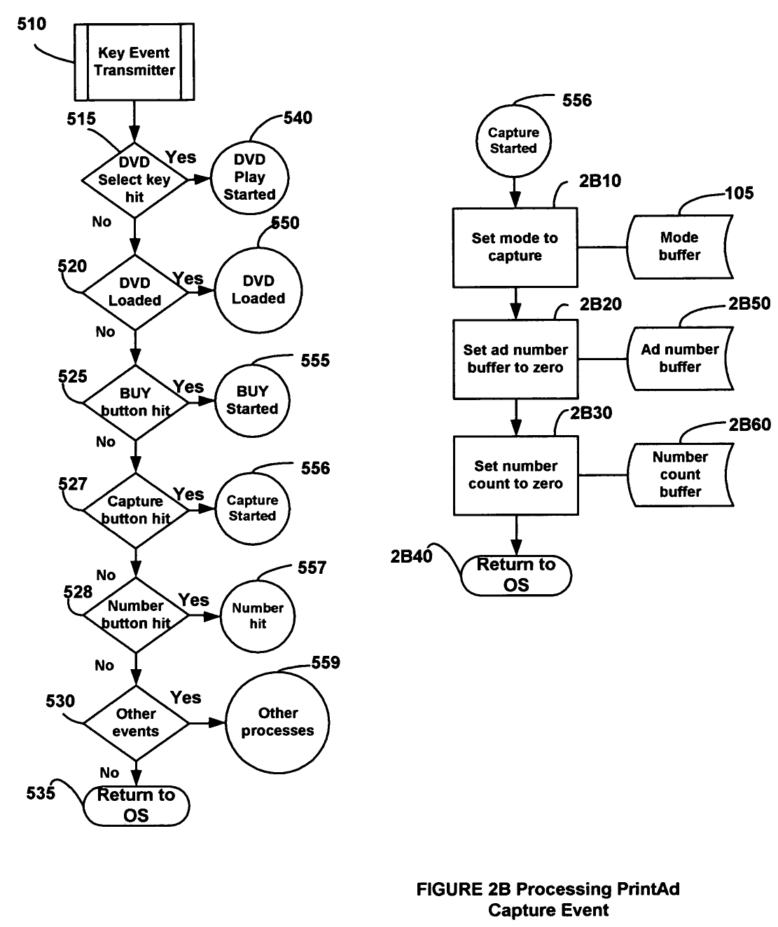

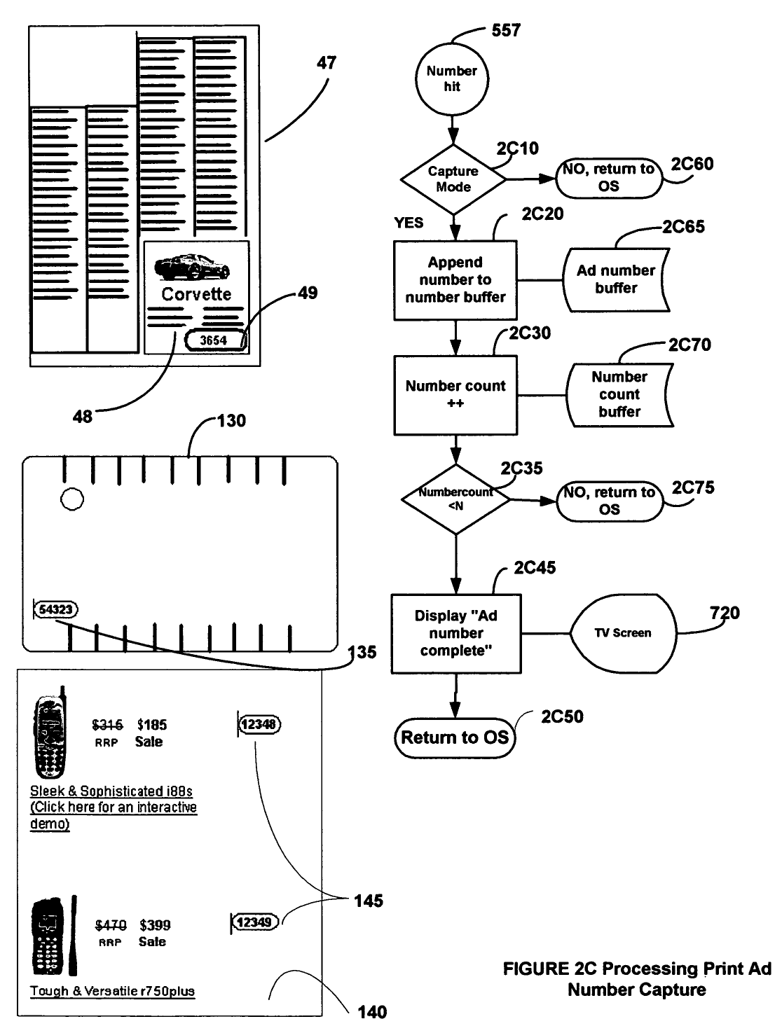

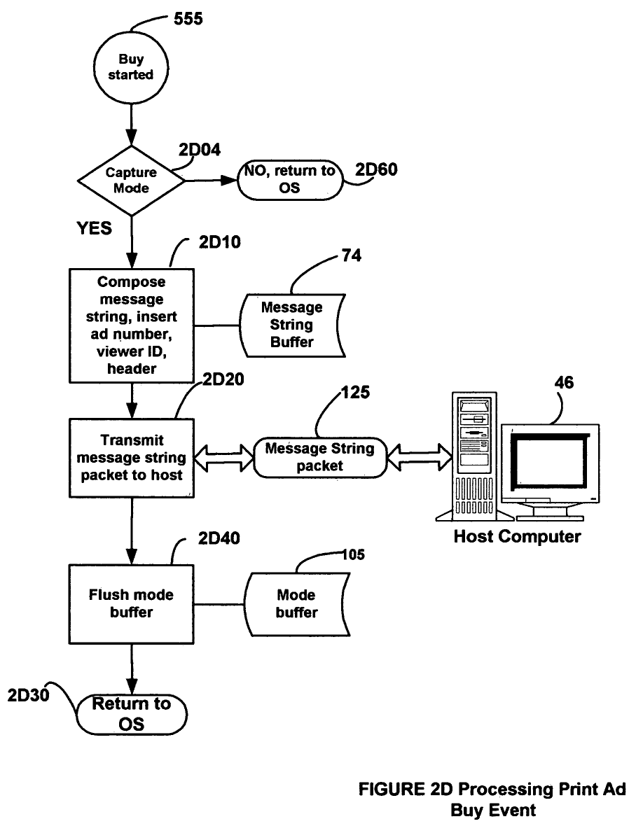

FIG. 2A displays a page from a print medium 47 that contains an ad 48 and an ad number 49. The user presses the Capture button 77 and then enters the ad number into the keypad 78 of the hand-held remote 30 and presses designated 36, if there is one. In the case of TiVo the user can press the Thumbs Up button. As each key is pressed the value is passed via the IR transmitter 32 to the IR receiver 40 in the DVR 67. The DVR composes the message string 38 composed of message type, ad number, city, date-time, Viewer ID, Phone number and stores it in the message sting buffer 74. The DVR then passes the message string 38 to the Host computer 46 either via the modem 42 and the phone system 44 or the Internet 19. The host determines the product from the ad number 49 and determines the appropriate vendor and the contacts the vendor 56, passing the viewer information and the product ID 54. The vendor contacts the viewer either through the phone system 44 or the Internet 23.

FIG. 2B displays a flowchart describing the steps that occur when the designated capture button is pressed on the remote and detected as a key event 510 and determined to be Capture button hit 527. Control is passed to Capture Started node 556. Next the mode buffer 105 is set to “Capture” by the process 2B10. The ad number buffer 2B50 is set to zero by the process 2B20. Then the number count buffer 2B60 is set to zero by the process 2B30. Finally, control is returned to the operating system 2B40.

FIG. 2C displays three forms of print ad and a flowchart describing the processing of print ad number capture. There are many possible forms of print ad. The first is a print media such as newspapers, magazines, books, flyers and other printed objects. The newspaper 47 contains an ad 48 and an ad number 49. A second example is a device, such as a mechanical air filter 130, embossed on the case is an ad number for the replaceable filter 135. A third example is a printed catalog 140. Shown are two items for sale. Next to each item are unique ad numbers 145.

The key event transmitter (FIG. 2B) 510 passes a number, detected at process 528 and then control is passed to the Number hit node 557. The capture mode is tested 2C10. If no, then return to operating system 2C80. If yes then append number 2C20 to least significant side of ad number buffer 2D65. Then increment number count 2C30 in number count buffer 2C70. Test if number count is less than predetermined size N. If no, return to operating system. The process Display “Ad number is complete” send the message to the TV screen 720, controlled by the DVR. The control is returned to the operating system 2C50.

FIG. 2D displays a flowchart describing the processing of a print ad designated buy key event. The key event transmitter (FIG. 2B) 510 passes a designated buy button hit, detected at process 525 and then control is passed to the Buy started node 555. Since there are multiple buy modes, the subject process tests if Capture Mode is true 2D04. If no, then return to the operating system 2D60. If yes process 2D10 composes the message string, composed of the message type, the ad number, viewer ID. The message string is stored in the message string buffer 74. Then the message string packet 125 is passed to the host computer 46. In FIG. 2A the host, determines the product ID from the ad number dataset and thence the vendor ID from the vendor dataset 62 and contacts the vendor 56, passing the viewer-product ID packet 54. The vendor contacts the viewer 66 via the phone system 44 or Internet 23. Meanwhile the mode buffer (FIG. 2D) 105 is flushed by the process 2D40. Then control is returned to the Operating system 2D30.

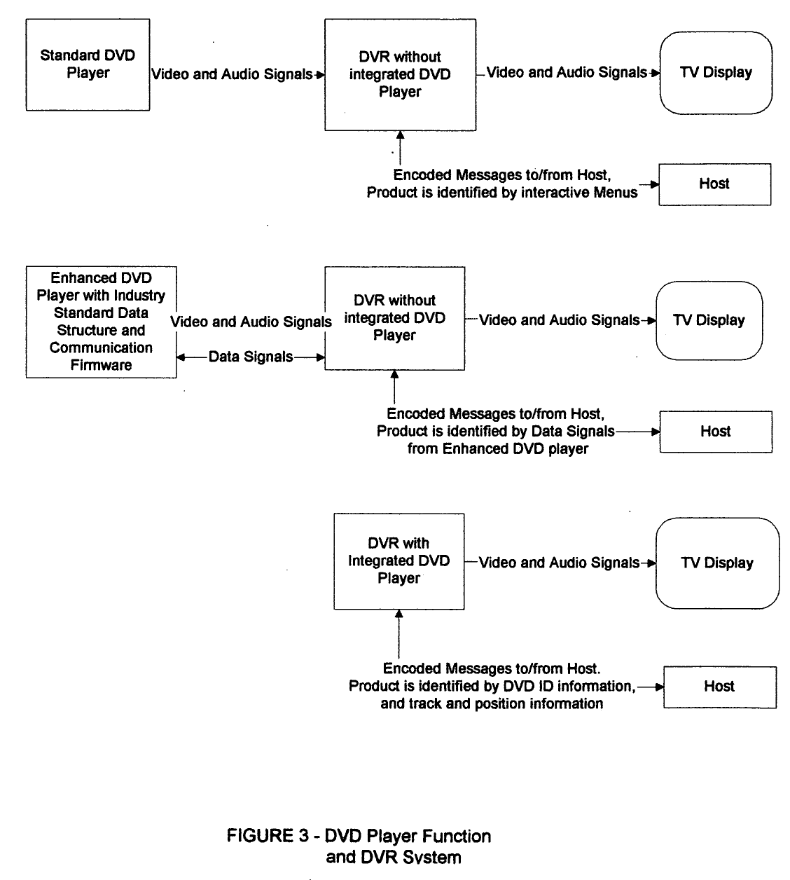

FIG. 3 displays the three variations of DVD players that might be considered for the DVR invention: 1) Separate DVD Player 75, Playing Through the DVR; 2) A Separate DVD Player Controlled by the DVR and Passing Data to the DVR; and 3) A DVD player integrated into the DVR.

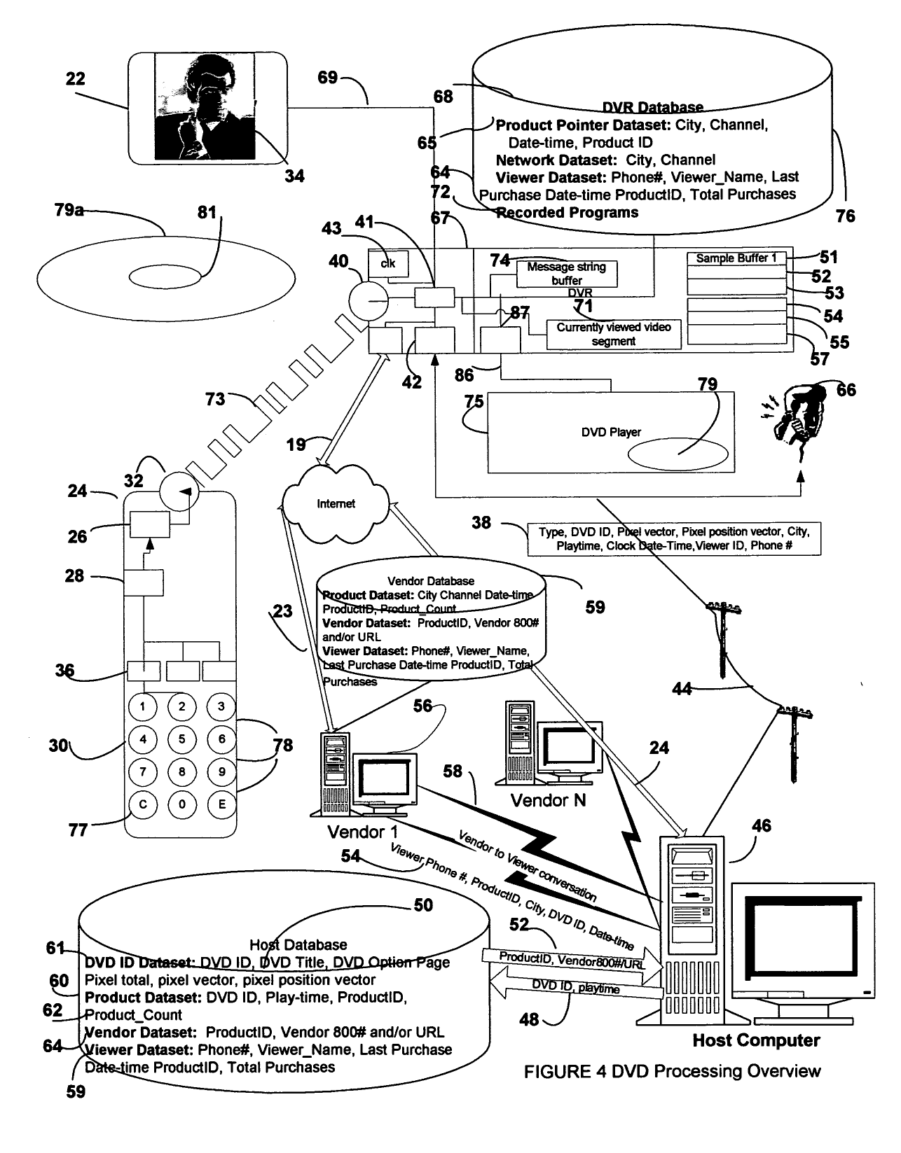

FIG. 4 displays the components involved in processing a viewer response to a DVD through the DVR. The major components are the DVR remote 30, DVD 79 and 79a, the DVD player 75, the video display 22, the DVR 67, the DVR database 68, the host computer 46, host database 50, the vendor computer 56 and the vendor database 59. The scenario begins when the viewer loads a DVD 79 into the DVD player. In this mode, the DVR can't read the data track on the DVD 81. The DVR 67 will detect at DVD is playing and will determine that the DVD is displaying the option page. Three or more samples will be taken of the options page. The pixel values and X, Y positions of the common edges will determine a unique set of numbers that can be matched with a stored set on the host computer DVD ID Dataset 61. This will yield the DVD ID and/or the DVD title. This information combined with the playtime will be used to identify the Product ID from the Product Dataset. The product ID will be used to determine the vendor phone number and/or URL from the Vendor dataset 64. The vendor 56 will be contacted and in turn the vendor will contact the viewer 66. More detailed steps are described below.

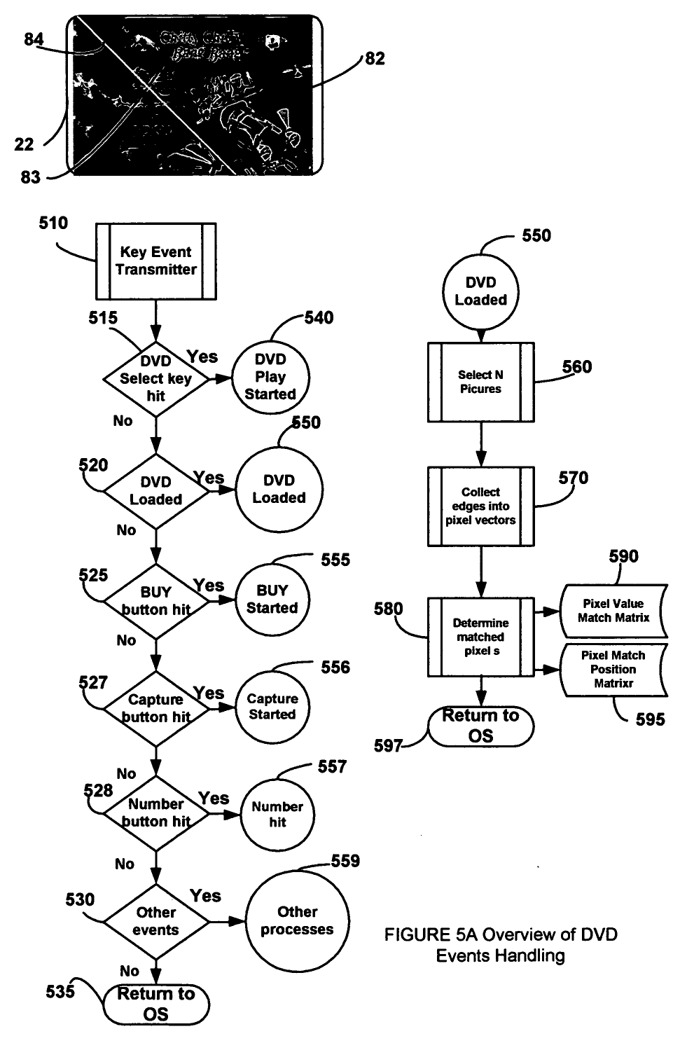

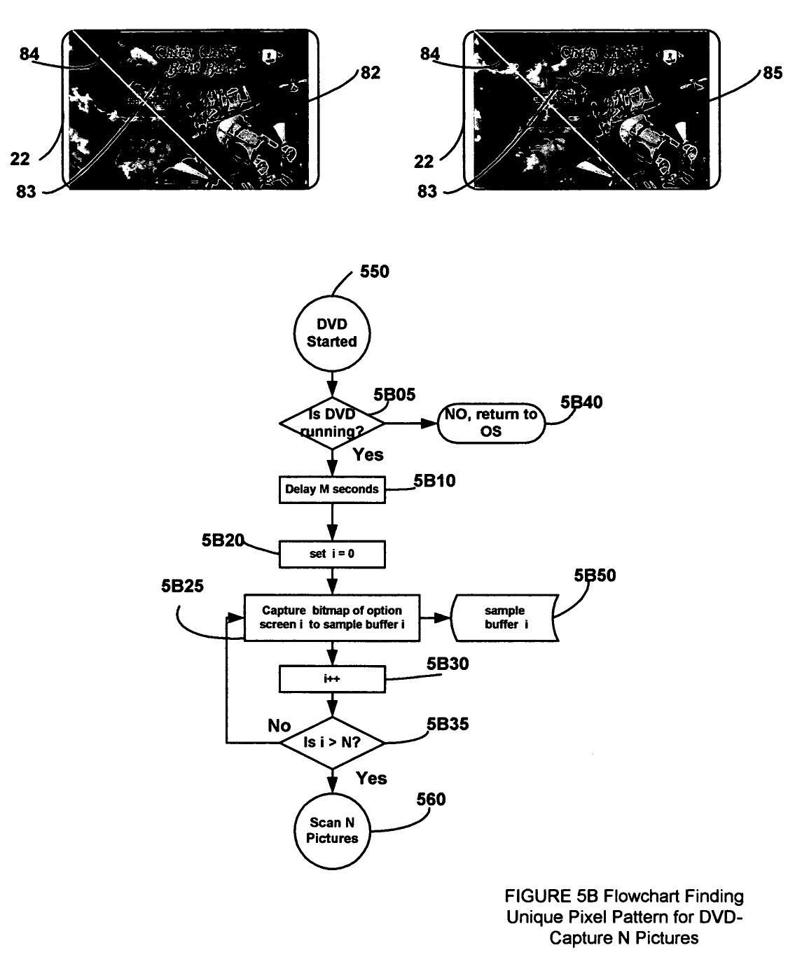

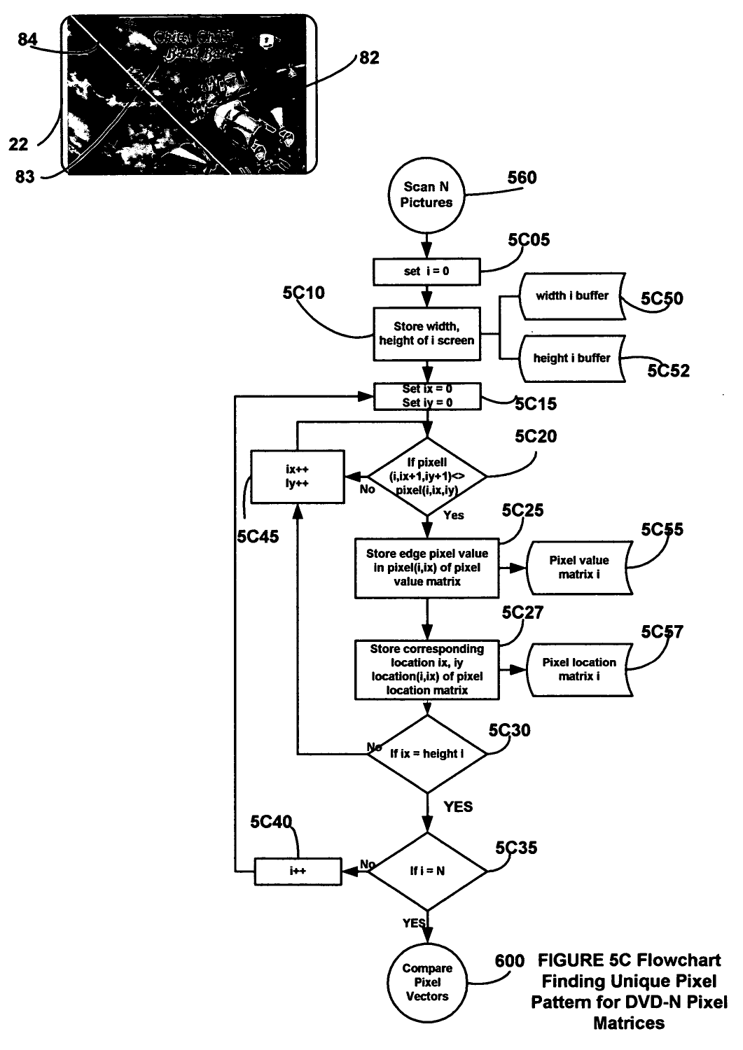

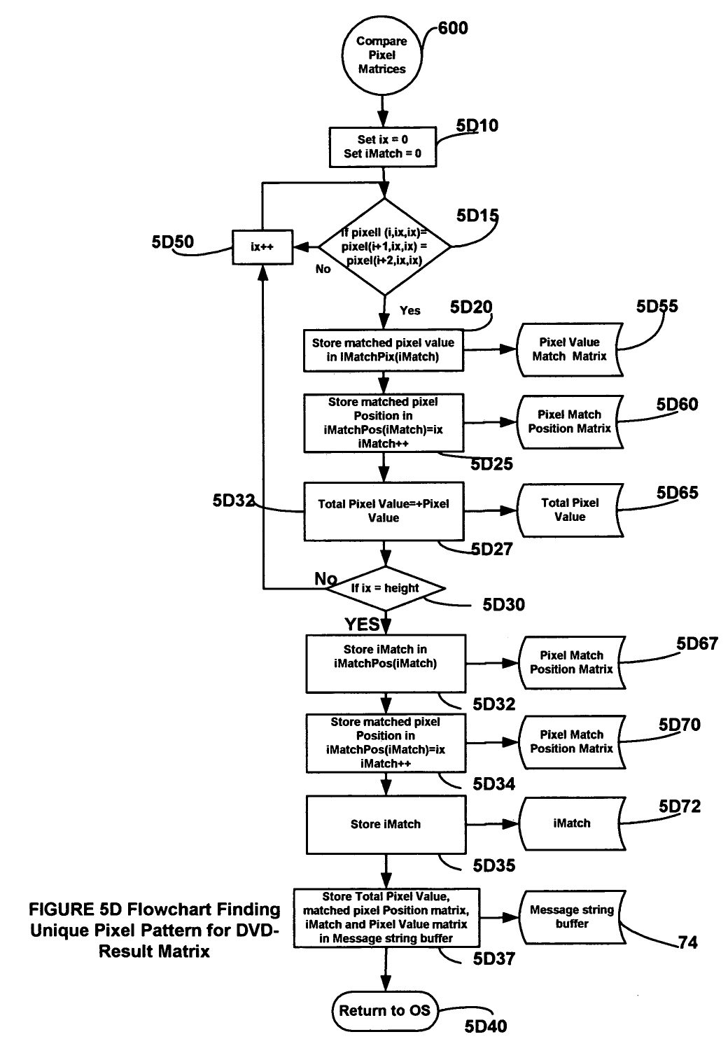

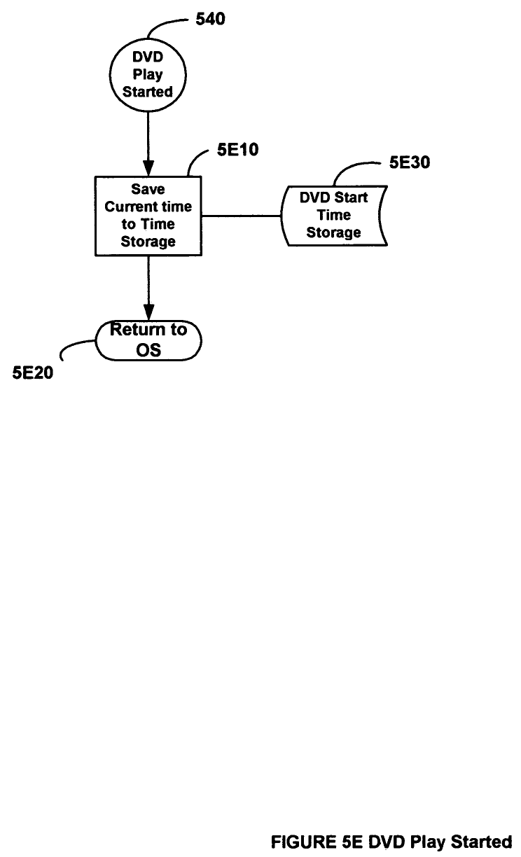

Overview of DVD Handling (FIG. 5A)

FIG. 5A displays an overview flowchart describing the handling of the key events beginning with the key event transmitter 510. The detailed steps are displayed in FIGS. 5B, 5C, and 5D. The DVR operation system provides a key event transmitter, equivalent to an interrupt stack 510. The program tests the key event transmitter with an IF statement 515 to determine if the DVD select key was hit. If yes, control is transferred to the DVD Play Started node 550. The DVD select key indicates that the viewer hit the select key to activate “Play”. If a DVD Loaded event is detected 520, control is passed to the DVD Loaded Node 550. If DVR remote's DESIGNATED button is detected 525, then control is passed to the Buy Started node 555. Detection of other events 530 causes control to be passed to other process nodes. If no key events are detected control is passed to the operating system 535;

The following is a brief summary of the flow after a DVD Loaded event is detected. When control has been passed to the DVD Loaded node 550, the process next the process selects N pictures 560 where N is greater than or equal to two. Next the process 570 scans a diagonal in each of the N pictures and selects the edges and stores the pixel locations. Edges are defined as a location where adjoining pixels have different color values. Next the process 580 determines if the edge pixels at the same locations are the same for all N pictures. If yes the pixel value and the pixel position are stored in match matrices 590 and 595 respectively. Following the last process 580, control is returned to the operating system (OS) 597.

Flowchart Capturing N Pictures of the DVD Options Page (FIG. 5B)

FIG. 5B displays a flowchart describing the capturing of N Pictures of the DVD options page. Where N is a number equal to or greater than two. The DVD options page contains the Play option and options to see behind the scenes information and other related pictures and music. After detecting the DVD started control is passed to the DVD Started entry point 550. The IF tests the current running of the DVD 5B05. If no, control is returned to the operating system 5B40. If yes, the process delays for M seconds 5B10 to pass over FBI warnings and other start up flash screens. The picture counter i is set to zero 5B20 followed by saving the bitmap of the then current option screen to the sample i buffer i 5B50. There are as many buffers as there are pictures of the option screen, at least two. The reason to take multiple samples of the option screen is to deal with the likelihood that the option screen is composed of fixed and variable content and some continuous fields separated by edges. After storing the ith bitmap the picture counter i is incremented 5B30. Note: we use the C++ programming language syntax for incrementing the value of i that is i++. Next if i is greater than N is tested. If i is greater, we pass control to Scan N Pictures node 560 (FIG. 5C). If no, then capture the next picture 5B25.

FIG. 5C Flowchart Finding Unique Pixel Pattern for DVD-N Pixel Matrices

FIG. 5C describes the process of capturing a linear collection of pixels from an initial x, y location to another xn, yn location. The pixels are compared to the neighboring pixel on the line. If they match in pixel values the pixel is skipped until a non-match is found. The non-match indicates an edge. Only edges are saved in the pixel matrix. The process is repeated for each of the N pictures. Then control is passed to compare pixel matrices (FIG. 5D). Control has been passed to the scan N pictures node 560, and then picture counter i is set to zero 5C05. The width and the height of the ith picture are stored in the memory means width i buffer 5C50 and height i buffer 5C52. Then the pixel location counters ix and iy are set to zero 5C15. Next the current pixel at xi, yi is compared with the pixel at xi+1, yi+1 5C20. An inequality implies an edge and equality is the result of a continuous color field. In the present invention we are interested in edges because it saves space and because edges in the same location imply the same option screen, with some variable pixels, but overlapping continuous fields of color imply very little. If the comparison indicates an edge the pixel value is stored in the pixel matrix i 5C55. Then the program compares ix with the height if the ith picture 5C30. If not equal the pixel locations ix and iy are incremented by 1 5C45. Control is the looped to the pixel edge test 5C20. If the ix is equal to the width i 5C30 then the program tests if i equals N (the number of pictures) 5C35. If no, then i is incremented 5C40 and control is looped to setting ix and iy to zero 5C15. If yes, control is passed to the compare pixel matrices node 600, which is continued, on FIG. 5D.

FIG. 5D Flowchart Finding Unique Pixel Pattern for DVD-Result Matrix

FIG. 5D displays a flowchart describing the finding of the unique pixel pattern for loaded DVD. The task is accomplished by comparing the pixel values of the N pictures and storing the location and pixel value of the pixels that match for all N pictures in a results matrix. This matrix will be unique to the DVD title. This unique result matrix can be transmitted from the viewers DVR to the host computer and compared with result matrices stored in a database at the host computer. Matching result matrices will yield the correct title of the DVD. If the program is run on the host computer the operator will enter the title of the DVD and the title will be stored in the host database along with the result matrix for the DVD. Control having been passed to the compare pixel matrices node 600, the pixel position ix is set to zero and the count of pixel matches, iMatch is set to zero. Now the program tests if all N pixels at the same location match each other 5D15. If no, then increment the pixel position ix and then loop to the N pixel match test 5D15. If the N pixels match each other, then store the pixel value 5D20 in the iMatch cell in the pixel match matrix 5D55. Then store the pixel ix position 5D25 in the pixel match position matrix 5D60. If the pixel x position doesn't equal the picture height 5D30 then increment the pixel position ix and loop to the N pixel test 5D15. If ix equals the width then return to the operating system 5D40.

DVD Play Started (FIG. 5E)

FIG. 5E displays the brief process when DVD Play Started is detected. Control is passed to the DVD Play Started node 540 and then to save current time to current time storage 5E10. The current time is saved to a field in the memory means called DVD Start time storage 5E30. The current time will be used to determine the playing time of the DVD. Then control is passed back to the operating system 5E20.

Flowchart Displays the Steps to Handling Designated Buy Key Event for DVD. (FIG. 5F)

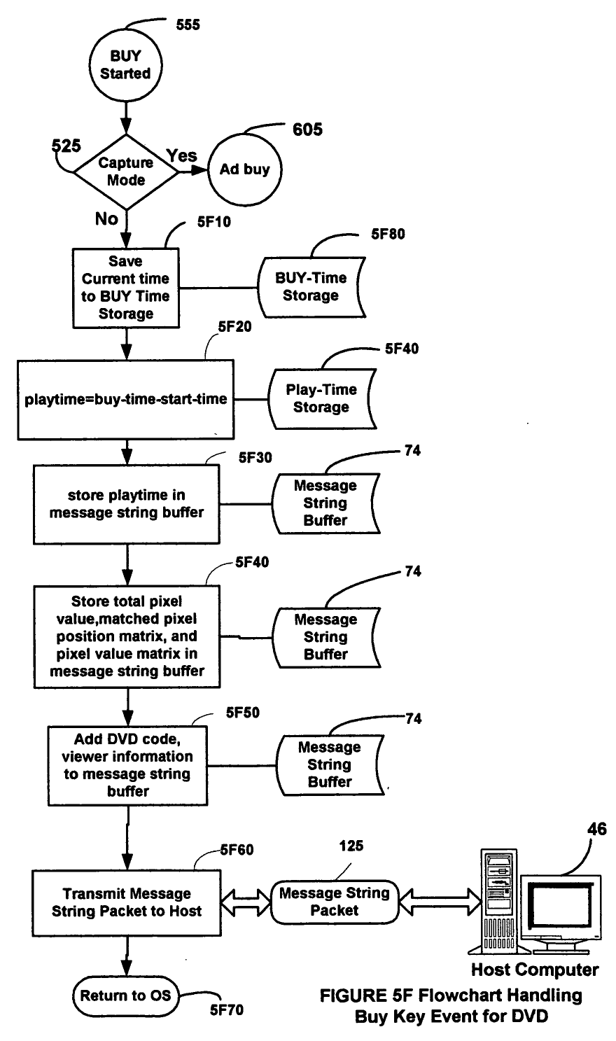

The designated buy key event is detected by the Key event transmitter FIG. 5A, 510. The key event transmitter transfers control, if designated buy button is hit 5A, 525, to the Buy started node 5F, 555. First the capture mode is tested. If yes, this means that the system is in Ad buy mode so control is passed to Ad buy node FIG. 6, 605. If no, then the buy refers to a commercial or product placement on a DVD or electronically transferred content. Next save the current time 5F10 to the buy-time storage 5F80. The computer calculates playtime from buy-time minus start-time 5F20 and store in Playtime storage 5F40. At step 5F40 store total pixel value, matched pixel position matrix, and pixel value matrix in message string buffer 74. Then Add DVD code, viewer information 5F50 to message string buffer 74. Then Transmit 5F60 Message String Packet 125 to Host 46. Then return to operating system 5F70.

Flowchart of the Ad Number Value Determination (FIG. 6)

The key event transmitter 610 detects the designated capture key hit 615. If yes then capture mode is set to true 635. Then the ad number buffer is flushed 640 because the designated capture key implies a new ad number. Then the number count of the number of digits is set to zero 645. The control is returned to the operating system 650. If any number hit 620 is yes, then capture mode equals true is tested 655. If no, control is returned to the operating system 660. If yes, number count is incremented by one 665. The number passed by the remote is appended 670 to the ad number buffer 715. Then “Ad number=”, and the adnumber buffer contents 675 is sent to the screen 720. The number count is tested against the maximum 680. If yes, control is returned to the operating system 725. If no, an error of input has occurred. Flush the ad number buffer 685. Set capture mode to false 690 and set number count to zero 700. Then send “Please press Capture and retype Ad number” 705 to screen 720. The control is returned to the operating system 710. If designated buy key hit 626 is yes, then pass number buffer contents 735 to message string buffer 74. The compose the rest of the message string 740, including at least the message type, ad number, viewer ID, date-time, viewer phone number and pass to message string buffer 74. Send “Thank you for selecting Ad number=”, adnumber 745 to screen 720. Send message string 750 to host 56. Flush the ad number buffer 755. Set capture mode to false 760 and set number count to zero 765. The control is returned to the operating system 770.

System Operation

The invention has five basic modes of operation. Modes a, b, and c relate to facilitating viewer purchases of products and the function of selecting the preferred power-on network or the preferred power-on channel based on a sponsor's commercials or product placements.

The modes are a) Direct feed of television broadcast via the DVR buffer to the television set display; b) Delayed feed of the television broadcast via the DVR buffer to the television set display; c) Recording of the television broadcast to the hard drive of the DVR and later playback; d) Playing of a DVD through a either DVR with integrated DVD player to the television set display or playing a DVD in a DVD player that is connected to the DVR and using the DVR/Handheld/Host infrastructure to facilitate viewer purchases of products; e) Using the DVR/Hand-held remote/infrastructure to facilitate viewer response to non-broadcast electronically transferred content ETC's f) Using the DVR/Hand-held remote/infrastructure to facilitate viewer response to print ads, catalogs and other indicators of available products, enhancing interaction with the vendor/advertisers.

Modes a, b and c can be considered together.

a, b, c) Television Broadcast Modes:

In FIG. 1 the television broadcast 20 feed 70 is passed either through a cable interface and/or a tuner to the digital video recorder (DVR) 67 via the video-in interface 21 and the signal is written to the buffer for currently viewed video segment 71. There is a delay from the time that the signal enters the DVR and exits the buffer to the television display 22. From the buffer, the signal is sent via the cable 69 or wireless device to the television display 22 and, if DVR is in record mode, to the DVR hard drive 76. When the viewer presses the designated buy button 36, the remote's microprocessor 28 generates a coded message and passes it to the infrared light (IR) controller 26 and then to the IR emitter 32 which issues an IR signal 73 that is beamed to the DVR IR receiver 40.

The remote's IR signal 73, with the encoded message, is processed by the DVR microprocessor 41. The DVR determines the nature of the remote's signal (FIG. 6). If the signal is a Buy command, indicated by pressing the designated buy key, then the DVR 67 creates a record 38 composed of record type, date-time, channel and city, viewer ID, and viewer phone number that is stored in the string buffer 74. The DVR dials the host computer 46 via the modem 42. When the connection is made, the data string 38 is passed via the communications line 44 to the Host Computer 46. In the event that the modem 42 determines that the phone line 44 is busy the controller 41 will schedule a redial at a later time. In the interim the DVR 67 can assemble more purchase records, limited only by the depth of its local memory. A portion of the hard drive 76 in the DVR 67 can be dedicated for this purpose and can easily be seen to have security and depth such that power loss or extended period of phone busy activity will not lose important purchase information. Alternatively, modem functions may be replaced by Internet or other forms of communication between DVR and host computer, as described previously.

d) DVD Playback Mode:

The fourth mode, (d), displayed in FIG. 4, occurs when playing of a DVD 79 through the DVR 67 to the television set display 22. There are essentially three modes in which a DVD 79 may be utilized with the present invention and which are depicted in FIG. 3: 1) Separate DVD Player 75, Playing Through the DVR; 2) A Separate DVD Player Controlled by the DVR and Passing Data to the DVR; and 3) A DVD player integrated into the DVR.

1) Separate DVD Player, Playing Through the DVR via an Interface:

In the first mode, shown in FIG. 4, a separate DVD player 75 is attached to the DVR system 67 via an interface 87. Such an interface could be via a separate coax, component video or an S-Video jack or a set of RCA jacks. In this mode the DVR 67 receives only a video and audio signal 80 from the DVD player 75 via the line in 86, but since the DVD is playing through the DVR it is known by the DVR that the information source is the DVD player by means of an interrogation by the DVR controller 41 as to the interface providing the current signal. While in this mode, the DVR will continuously capture a portion of the video signal into the current signal buffer 71 for capture and comparison to known video patterns as explained below.

Key to allowing the viewer to purchase items advertised overtly or by product placements in a movie is the identification of the DVD disk being played. The sampling and analysis method described here allows the DVD disk to be identified and that identification passed to the host computer. Since nothing more than the video signal is available to the DVR to process, some method of analyzing the video signal must allow identification of the DVD disk. Most DVD's have an options or title screen 82 (shown in FIG. 5) that remains on the screen until the viewer presses the select key on the DVD remote. Such options often include play first track, play some specific track and exit. The DVR will capture the options screen 82 and will sample a significant portion of the option screen, which could include a vertical band, horizontal band and/or a diagonal band. The sampling function displayed in FIG. 5, will select the unchanged portions of the selection or bands. Text generally doesn't change on DVD option screens. Often there may be artwork that doesn't change as well. The sampling function will store a measurement of the red, green and blue pixel values and their sequence in a buffer dedicated for this purpose. This sequence of values will be unique for every DVD options page. That is, for each DVD title there is a unique sequence of pixels. The Host computer 46 will have stored the pixel sequences in a field of the Product Dataset 60 for later matching. Some processing of the pixel sequences may be additionally required, such as filtering and range adjustment, because of the quality and variability of the signal source, i.e., the DVD player. Thus the screen band capture buffer contents become a special case of the data structure to allow DVD information to be utilized for the invention. There are many possible stable screens that do not represent the options screen, which must be discarded. Examples of the stable screens that do not reflect unique information that may identify the DVD disk include credit screens, FBI warning screens, studio name screens, and the like. The DVR must now be triggered to capture the screen buffer at the right time that represents this stable menu information such that the DVD disk may be identified.

If the DVR IR receiver 40 detects a DVD player remote direction key (right, left, up, down) or a select or play key pressed by the viewer then this is the trigger that tells the DVR to capture the pixel sample sequence and store it in the band buffer for use later if and when the designated buy button 36 is pressed. This action signifies that the DVD player is presenting a stable menu screen to the viewer and that a recognizable pattern, called the Title Pattern, should be present for analysis. It is possible to use several patterns to identify a DVD, all of which represent stable screens that may be unique to that particular title. When the DVR IR receiver 40 detects the remote's signal to play the DVD the DVR will record the start time of the DVD and store it in the Start Time buffer 90. It should be mentioned that the DVR may be continuously feeding screen (i.e. video signal) information into a buffer until the trigger occurs and that the trigger may identify the point at which the end of capture should occur, thus complete screen information would already be present in a buffer at the time that the trigger occurs (this is similar to a post-trigger sample in an oscilloscope). The time at which the viewer pressed the Play button would be captured for use in determining the time lapse when other actions, such as pressing the Buy button, occur.

An example of this use could be if the viewer 66 placed a DVD of James Bond in “Golden Eye” or other DVD 79 in the DVD Player 75. When the movie is started after presentation of the menu screen, the DVD would be prepared for identification by the pattern captured from the options screen. At say 45 minutes from the start time, Mr. Bond looks at his Omega watch. The viewer hits the Buy button 36. When the viewer hits the Buy button 36, the DVR will capture the DVR's the current dock time and subtract the start time, stored in the Start Time buffer 90. The result is called the playtime and is stored in the Message String buffer 74. The Message String buffer 74 is loaded with the Viewer information and the message type. The DVR contacts the host computer via the modem means or other contact means and transfers the type of record information (a DVD transaction), the viewer information, the buffer representing the portion of the menu screen with the captured pixels, the playtime since the start of the DVD. The host is then free to attempt to analyze the pixel information so that the DVD may be identified, the product in the DVD identified after which the sales information is passed on to the vendor in a manner similar to the other types of transactions.

The present invention will work with all existing DVD's that have options screens. DVDs that do not have Options Screens or are otherwise not identifiable would result in a request to the user when the host computer contacts the viewer. The product could be directly identified or the movie so that the product may be identified indirectly. If the DVD title is not identified the information available is passed to the host and the viewer is asked which DVD he/she is watching. The fact the viewer wanted to buy something seen on a DVD is valuable to a potential vendor, who can be expected to pay the DVR operator for the contact.

2) A Separate DVD Player Controlled by the DVR and Passing Data to the DVR:

In this mode the DVR communicates to the DVD player 75 over some form of communication link (serial cable such as RS-232, IEEE-1394, i-Link, optical or coax, radio frequency link such as Blue-Tooth, or any other form that allows two-way reliable transfer of data between devices, etc.) and is able to interrogate the DVD player for DVD title and identification information (which is contained in a special track on all DVD disks) and for playback status information, such as track and position within the track information so that it can easily be determined what is being viewed on the DVD.

As an example of the use of this mode we can consider the following scenario. The viewer 66 has (again) placed a DVD of James Bond in “Golden Eye” in the DVD player and is viewing the movie. At 45 minutes from the start Mr. Bond looks at his Omega watch. The viewer, interested in purchasing a watch like Mr. Bond's hits the Buy button 36. When the viewer hits the Buy button 36, the DVR will interrogate the DVD player for DVD identification information stored on the information track 81, along with playback status information such as track and track position. It will then assemble a data record similar to that of a television broadcast, and along with the viewer information will transfer this data record to the host computer, again in a similar manner to the other methods. The host computer will separate out the components of the data record, recognize that the viewer is watching the “Golden Eye” DVD and is interested in the product placement that is present 45 minutes into the movie, i.e., the Omega watch. The host computer will also recognize the viewer from the record information and will contact the vendor associated with the Omega watch for a sales contact with the viewer.

3) A DVR with an Integrated DVD Player

In the third mode, the DVD player 75 is integrated into the DVR 67 and any data on the information track 81 contained in the DVD 79 and 79a is automatically available to the DVR 67 for use in relaying product information 38 when the viewer presses the Buy Button 36. TiVo already produces a form of DVR 67 with integrated DVD player 75. The present invention can process DVD's in all three modes representing the three types of DVD player configurations, as explained in examples a), b) and c) above.

Print Advertisement Capture Mode

FIG. 2A displays a system to interface print ads with the DVR and thence the host computer and thence the vendor computers. Shown is a print ad 47. At the lower right of the page is an ad 48 and embedded in the ad is the ad number 49. Each ad has a unique number. The number can be composed of 1, 2, 3, 4, 5, or 6 or more digits. The numbers will be licensed to advertisers. Numbers could additionally be reserved for voting, surveys, TV audience response and special functions.

When number keys are pressed on remote controls they are assumed to be channel selections unless immediately preceded by a special function key. In most remote controls only the last three digits are kept from a string of digits entered by the viewer and after a suitable delay the channel represented by the last one to three digits is assumed to be the desired channel. To differentiate between a channel selection and a print ad, a designated capture button is pressed. This will cause the DVR to ignore the numbers as channel numbers and wait for the buy button.

An advertiser may purchase more than one ad number 49 for an ad, depending on the response option. For example one ad number for an immediate contact, a second ad number to be mailed literature, or a third ad number to be contacted by a local representative. The viewer uses the remote to capture the print ad number and transmit the print ad number to the DVR and thence to the host computer and thence to the vendor's computer. The vendor then contacts the viewer. The print ad response scenario is as follows: The user 66 sees a print ad 48 and wishes to make an easy contact with the advertiser. The user clicks the designated capture button and then types the ad number 49 into the number keys 78 of the hand-held remote 30. After the last digit, the user presses the Buy key 36. The DVR will interpret the sequence initiated by the Capture button as an ad number, whereupon it would assemble a print ad packet record to be sent to the host computer for a sales contact. If the viewer fails to press the Buy button within a specified time the ad number buffer is flushed.

Because print media can be circulated to multiple cities, the city portion of the transmitted record may have little information value. The same ad number can be used in nation-wide circulation magazines and newspapers. Conversely, the city code may impart area specific information to the vendor, such as sales tax, local restrictions or requirements, or features that are area-specific.

It is possible for the viewer to be using the remote in a room without a line of sight pathway to the DVR when a print ad number is being entered. This could make present a problem for standard remotes in which information travels only from the remote to the device controlled over an IR communication pathway. A method to solve this problem could be to include a reverse pathway for the IR so that the remote could be certain that its packet record was received by the DVR. Another method would be to use RF or another method similar to those mentioned in the description of assumptions described at the beginning of this discussion, thus ensuring reliable bi-directional communication between the remote control and the DVR.

Database Contents

The DVR hard drive contains a database that includes at least distribution information, locale information, and viewer information. Contained within this database are such items as viewer name, viewer address (including city, state, zip code, etc.), viewer phone number, viewer financial information (if agreed to by the viewer), host phone access numbers, Internet access phone numbers, local channel mappings, and power-on channel or date-time channel pairs and sponsor mappings and date-time directives as may be useful in conduction of sales transactions. All of this information may be set up at DVR installation time or remotely by the host upon the first transaction with the viewer.

The Host computer contains a plurality of databases that are linked to provide the host the ability to contact the appropriate vendor based on city, date-time and channel or DVD title and playtime. Included is the Product Dataset 60 that maps date-time, Channel and City data of sponsors' commercials and product placements to product identifications.

As shown in FIG. 1 the Vendor computer 56 contains a database 59, which contains plurality of datasets 60, 62, 64 that are designed to support the products they advertise along with customer information. By assembling customer information, as sales are generated, the vendors can perform market research to fine tune commercial and product placements based upon results by city and time slots as well as individualized advertisement delivery. In utilizing this function, the Vendor may work with the Host and broadcast service providers to provide custom advertisements to viewers or regions depending upon the market research results.

Overview of Host DVD Handling

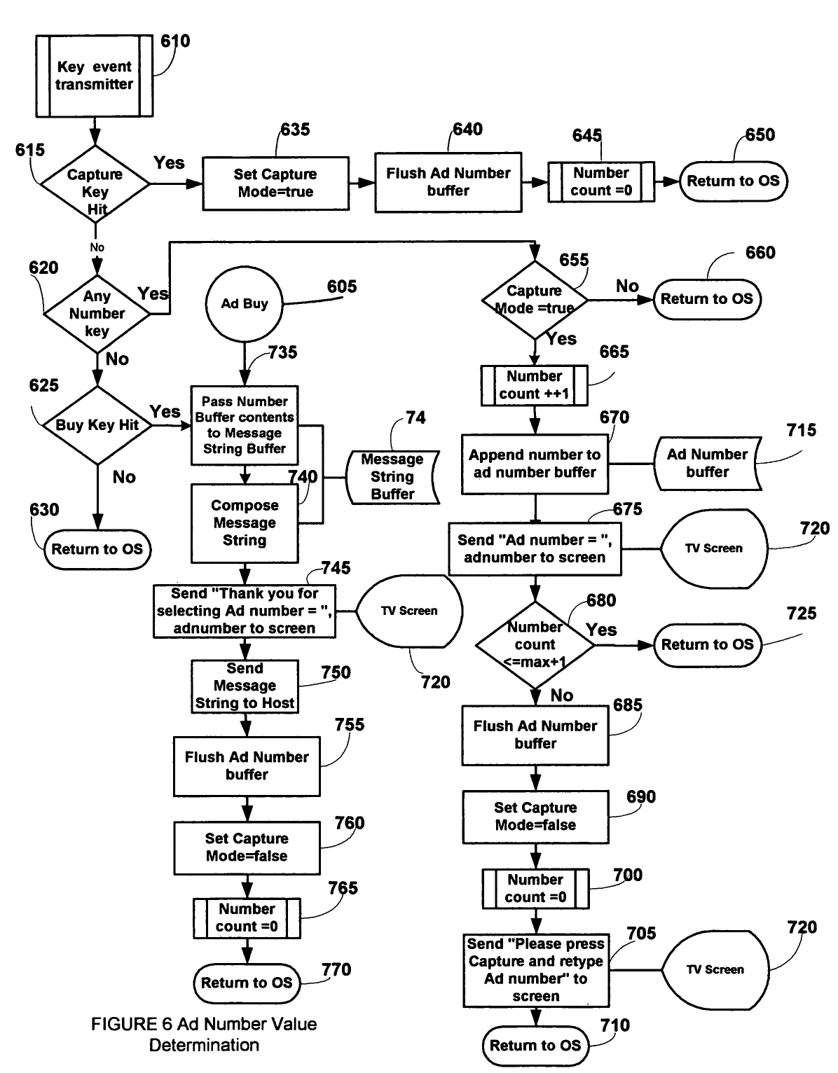

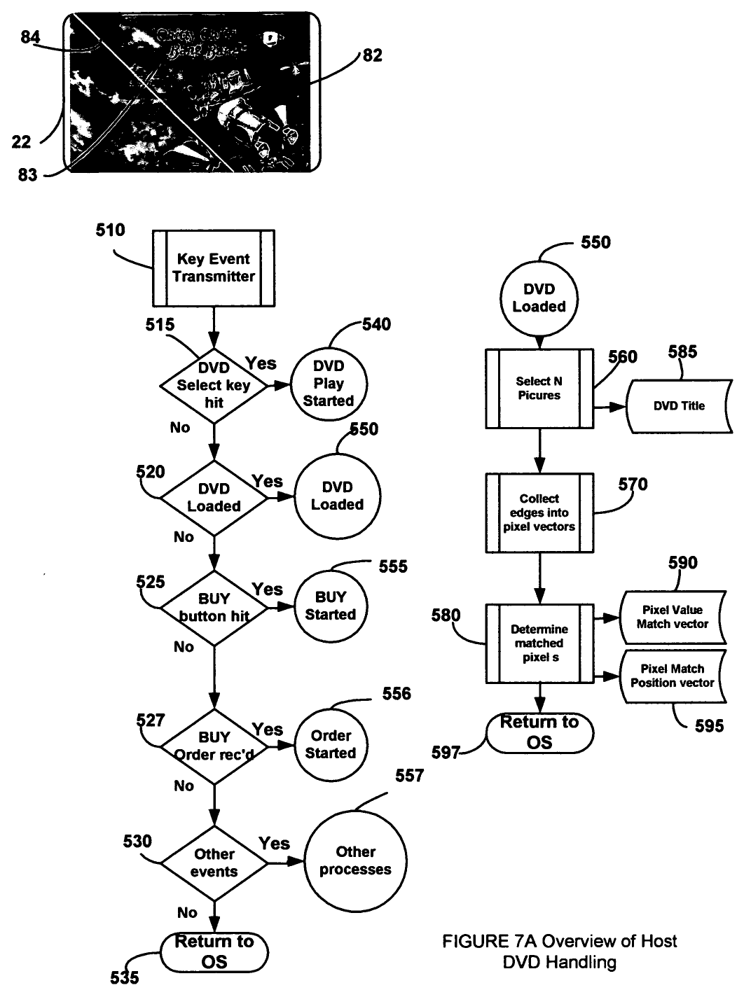

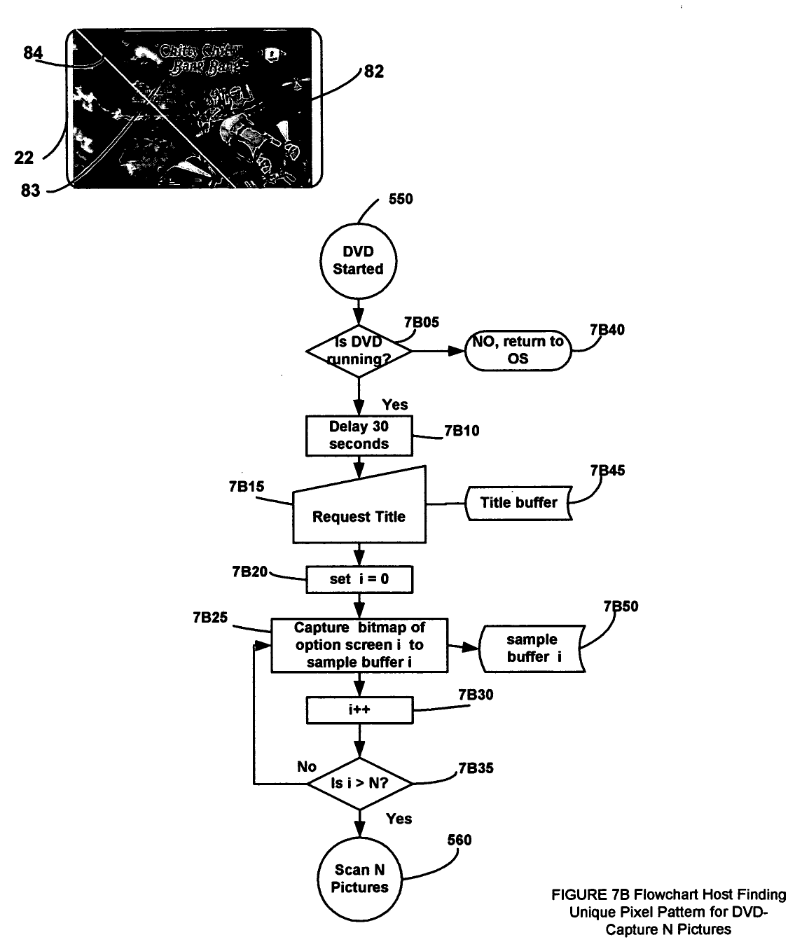

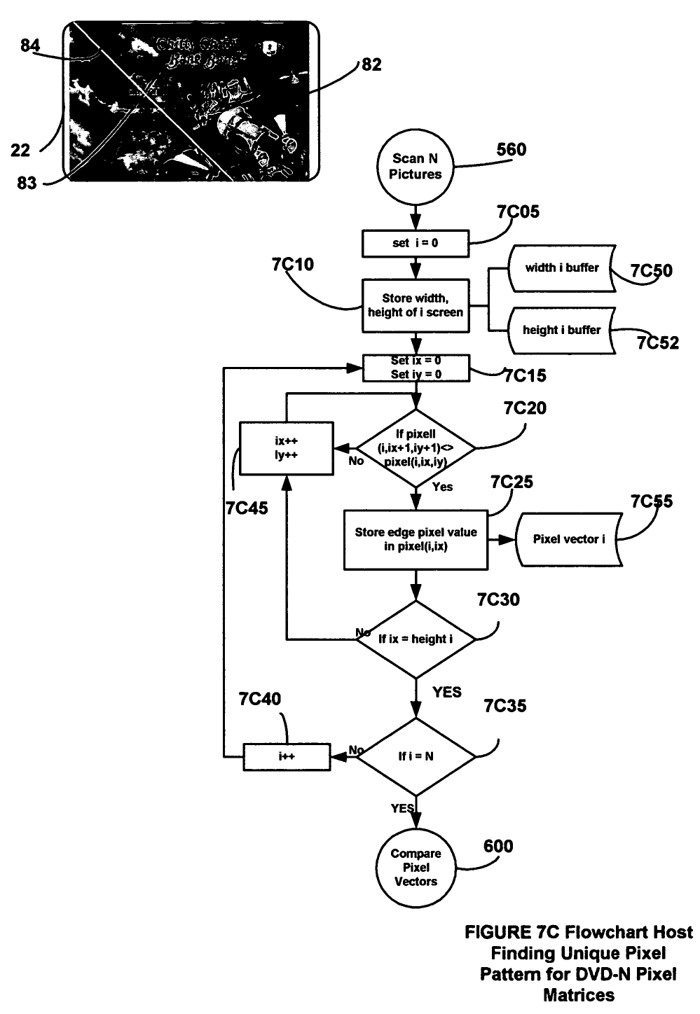

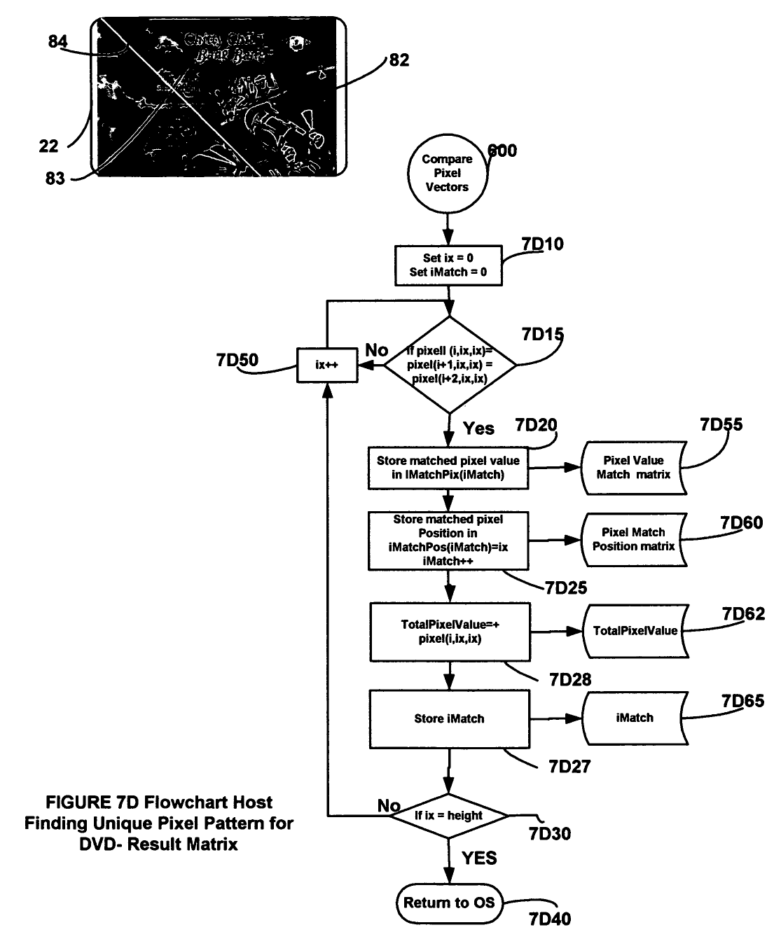

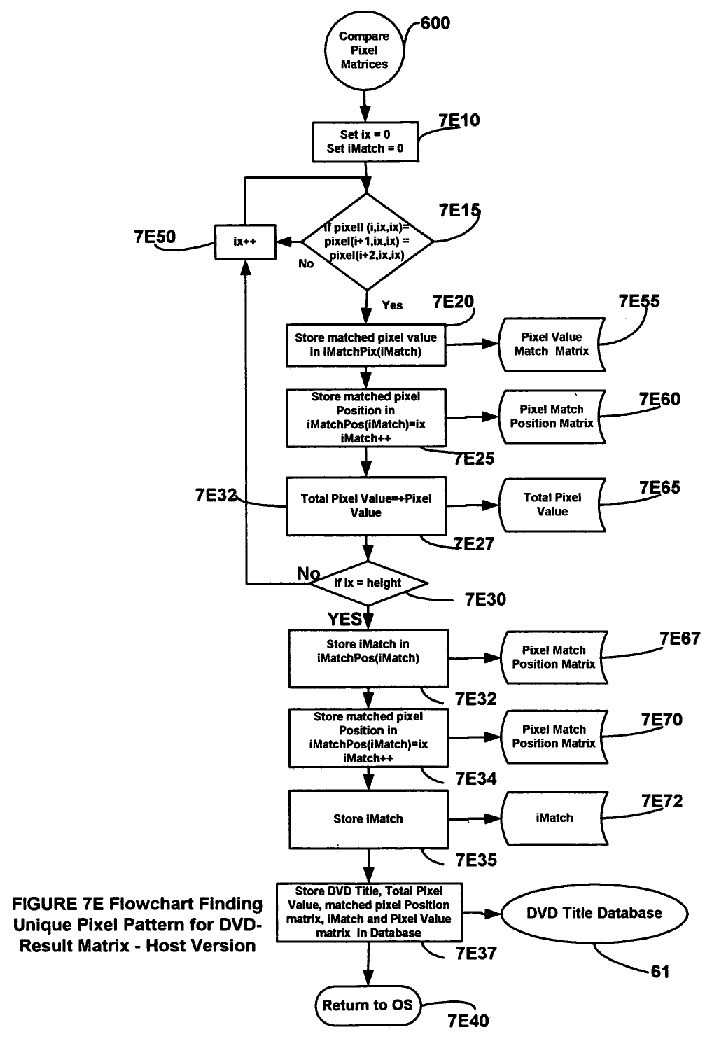

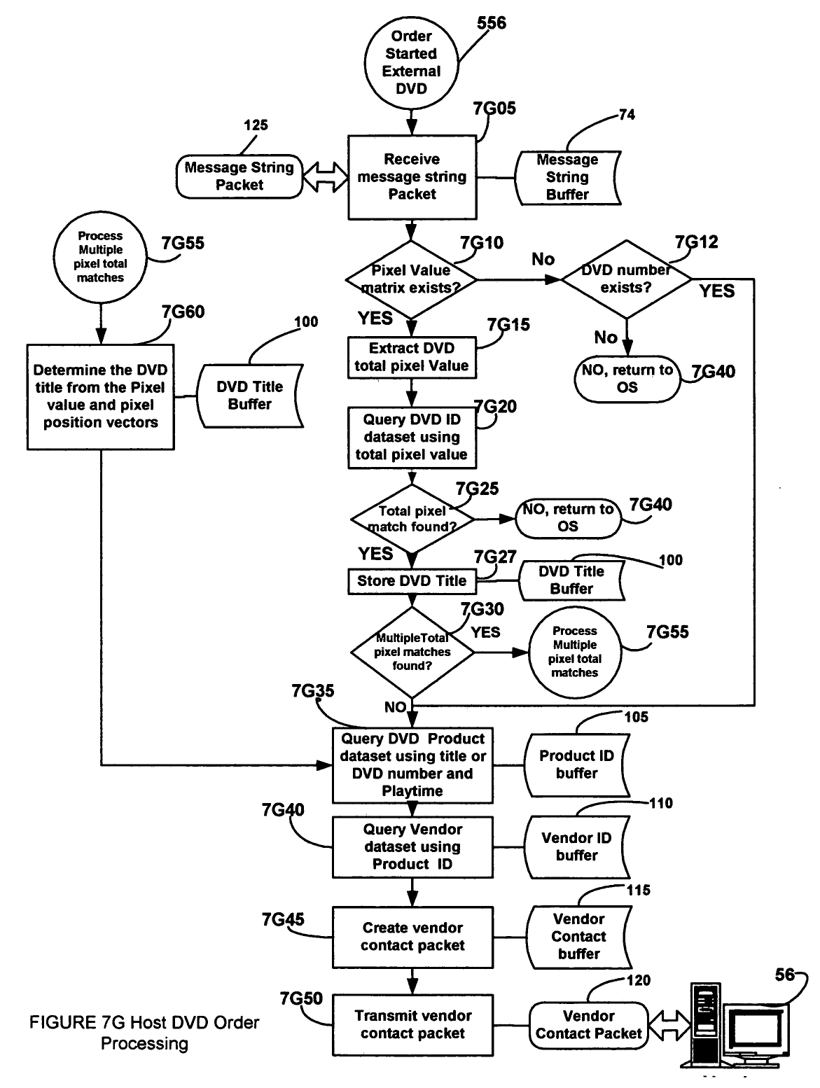

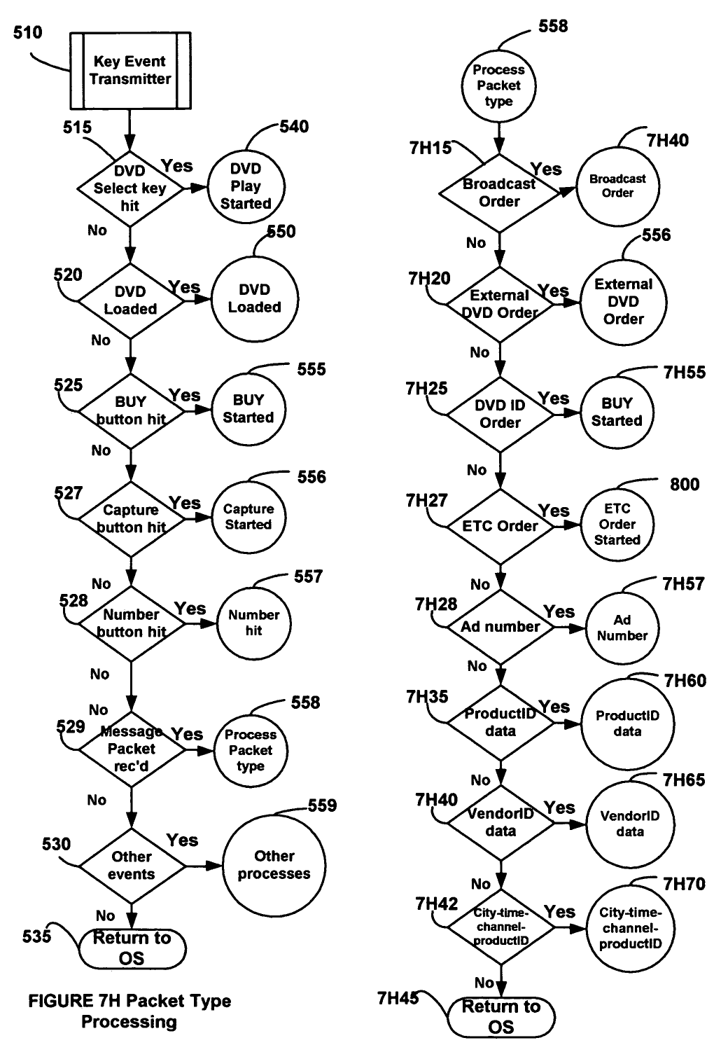

FIG. 7A displays an overview flowchart describing the handling of the key events on the host computer, beginning with the key event transmitter 510. The detailed steps are displayed in FIGS. 7B, 7C, 7D, 7E, 7G, and 7H.

The purpose of similar procedures on the viewers' DVR's and the host computer is to assure that DVD options screen sampling will be accomplished in substantially the same manner so the results can be compared and yield matches when the same DVD title is viewed.

The DVR operation system provides a key event transmitter, equivalent to an interrupt stack 510.

The program tests the key event transmitter with an IF statement 515 to determine if the DVD select key was hit. If yes, control is transferred to the DVD Play Started node 550. The DVD select key indicates that the viewer hit the select key to activate “Play”. If a DVD Loaded event is detected 520, control is passed to the DVD Loaded Node 550. If DVR remote's BUY button is detected 525, then control is passed to the Buy Started node 555. Detection of other events 530 causes control to be passed to other process nodes. If no key events are detected control is passed to the operating system 535.

The following is a brief summary of the flow after a DVD Loaded event is detected. When control has been passed to the DVD Loaded node 550, the process next selects N pictures 560 where N is greater than or equal to two. Next the process 570 scans a diagonal in each of the N pictures and selects the edges and stores the pixel locations. Edges are defined as a location where adjoining pixels have different color values. Next the process 580 determines if the edge pixels at the same locations are the same for all N pictures. If yes the pixel value and the pixel position are stored in match matrices 590 and 595 respectively. Following the last process 580, control is returned to the operating system (OS) 597.

Flowchart Host Finding Unique Pixel Pattern for DVD-Capture N Pictures (FIG. 7B)

FIG. 7B displays a flowchart describing the capturing of N Pictures of the DVD options page, where N is number equal to or greater than two. The DVD options page contains the Play option and options to see behind the scenes information and other related pictures and music. After detecting that the DVD has started control is passed to the DVD Started entry point 550. The IF tests the current running of the DVD 7B05. If no, control is returned to the operating system 7B40. If yes, the process delays for M seconds 7B10, to pass over FBI warnings and other start up flash screens. Then the user is requested to type in the DVD title 7B15, which would be stored in a title cell in the memory means 7B45. The input request times out after 10 seconds, passing control to the next step. The picture counter i is set to zero 7B20 followed by saving the bitmap of the then current option screen to the sample i buffer i 7B50. There are as many buffers as there are pictures of the option screen, at least two. The reason to take multiple samples of the option screen is to deal with the likelihood that the option screen is composed of fixed and variable content and some continuous fields separated by edges. After storing the ith bitmap the picture counter i is incremented 7B30 Note: we again use the C++ programming language syntax for incrementing the value of i which is i++. Next if i is greater than N is tested. If it is greater, pass control to Scan N Pictures node 560 (FIG. 7C). If no, then capture the next picture 7B25.

Flowchart Host Finding Unique Pixel Pattern for DVD-N Pixel Matrices (FIG. 7C)

FIG. 7C describes the process of capturing a linear collection of pixels from an initial x, y location to another xn, yn location on the host computer. The pixels are compared to the neighboring pixel on the line. If they match in pixel values the pixel is skipped until a non-match is found. The non-match indicates an edge. Only edges are saved in the pixel matrix. The process is repeated for each of the N pictures. Then control is passed to compare pixel matrices (FIG. 7D). Control has been passed to the scan N pictures node 560, and then picture counter i is set to zero 7C05. The width and the height of the ith picture are stored in the memory means width i buffer 7C50 and height i buffer 7C52. Then the pixel location counters ix and iy are set to zero 7C15. Next the current pixel at xi, yi is compared with the pixel at xi+1, yi+1 7C20. An inequality implies an edge and equality is the result of a continuous color field. In the present invention we are interested in edges because it saves space and because edges in the same location imply the same option screen, with some variable pixels, but overlapping continuous fields of color imply very little. If the comparison indicates an edge the pixel value is stored in the pixel matrix I 7C55. Then the program compares ix with the width if the ith picture 7C30. If not equal the pixel locations ix and iy are incremented by 1 7C45. Control is the looped to the pixel edge test 7C20. If the ix is equal to the width i 7C30 then the program tests if i equals N (the number of pictures) 7C35. If no, then i is incremented 7C40 and control is looped to setting ix and iy to zero 7C15. If yes, control is passed to the compare pixel matrices node 600, which is continued, on FIG. 7D.

Flowchart Finding Unique Pixel Pattern for DVD-Result Matrix (FIG. 7D)

FIG. 7D displays a flowchart describing the finding of the unique pixel pattern for loaded DVD. The task is accomplished by comparing the pixel values of the N pictures and storing the location and pixel value of the pixels that match for all N pictures in a results matrix. This matrix will be unique to the DVD title. This unique result matrix can be transmitted from the viewers DVR to the host computer and compared with result matrices stored in a database at the host computer. Matching result matrices will yield the correct title of the DVD. If the program is run on the host computer the operator will enter the title of the DVD and the title will be stored in the host database along with the result matrix for the DVD. Control having been passed to the compare pixel matrices node 600, the pixel position ix is set to zero and the count of pixel matches, and iMatch is set to zero. Now the program tests if all N pixels at the same location match each other 7D15. If no, then increment the pixel position ix and then loop to the N pixel match test 7D15. If the N pixels match each other, then store the pixel value 7D20 in the iMatch cell in the pixel match matrix 7D55. Then store the pixel ix position 7D25 in the pixel match position matrix 7D60. If the pixel x position doesn't equal the picture width 7D30 then increment the pixel position ix and loop to the N pixel test 7D15. If ix equals the width then return to the operating system 7D40.

Flowchart Finding Unique Pixel Pattern for DVD-Result Matrix—Host Version (FIG. 7E)

The process compares the ix pixels from all three pixel edge matrices. A three-way match implies that the pixel will be the same for all frames of the option page. The unchanging pixels will represent a unique pattern that should serve to determine the DVD uniquely and thus provide a proxy for the title or DVD ID. In addition the total value of the pixel vales and the number of matched pixels will serve as a quick search item which will lead to a single or a few hits that will point to the DVD ID. The process begins with Compare Pixel Matrices node 600. First Set ix=0 and Set iMatch=0 7E10. Then compare the edge pixel values in ix cell from the three matrices: If pixel (i,ix,ix)=pixel (i+1,ix,ix)=pixel (i+2,ix,ix) 7E15. If no, increment ix 7E50 and loop back. If yes, Store matched pixel value in IMatchPix(iMatch) 7E20, the Pixel Value Match Matrix 7E55. Then Store matched pixel Position in iMatchPos(iMatch)=ix and increment iMatch++ 7E25, (the matrix pointer), in the Pixel Match Position Matrix 7E60. Next compute Total Pixel Value=+Pixel Value=+Pixel Value 7E32 and store in Total Pixel Value buffer 7E67. Then test If ix=height 7E30. If no, loop back to increment ix 7E50 and the complete loop back. If yes, Store iMatch 7E32 in iMatchPos(iMatch) (Pixel Match Position Matrix) 7E70. Then Store matched pixel Position in iMatchPos(iMatch)=ix and increment iMatch++ 7E34. Then store the total match count iMatch 7E35 in the buffer 7E72. To complete the process Store DVD Title, Total Pixel Value, matched pixel Position matrix, iMatch and Pixel Value matrix 7E37 in Database 61 Finally return to the operating system 7E40.

Flowchart Host DVD Order Processing (FIG. 7G)

The flow chart describes the steps in the host handling an order received from a viewer's DVR. The message type that heads the message string packet 125 declares that the order is based on a DVD. The Order Started external DVD node 556 is entered when the Buy order received is detected 1, 527. The buy order comes as a message string packet 125. It is detected by the operating system and then is available for processing 7G05, which passes it to the Message string buffer 74. The message string buffer is examined for the presence of a pixel matrix 7G10. This can be accomplished by testing the heading for message type. If pixel matrix exists is no, then test if DVD number exists 7G12. If no, then return to operating system 7G40. If yes, pass control to 7G35. If pixel matrix exists is yes, then extract the total pixel value 7G15. Then query the DVD ID dataset (FIG. 4, 61) using the total pixel value 7G20. Test if total pixel match found 7G25. If no, return to operating system 7G40. Place the DVD title 7G27 in the DVD title buffer 100. Test if multiple total pixel matches found 7G30. If yes, go to process multiple pixel matches 7G55. Determine the DVD title from pixel value and pixel position matrices 7G60 and store the DVD title in the buffer 100. If multiple total pixel matches found is no, query DVD Product dataset (FIG. 4, 60) using title and playtime 7G35, placing product ID in buffer 105. Create vendor contact packet 7G45 and place in vendor contact buffer 115. Transmit vendor contact packet 7G50 via packet 120 to vendor computer 56.

Packet Type Processing (FIG. 7H)

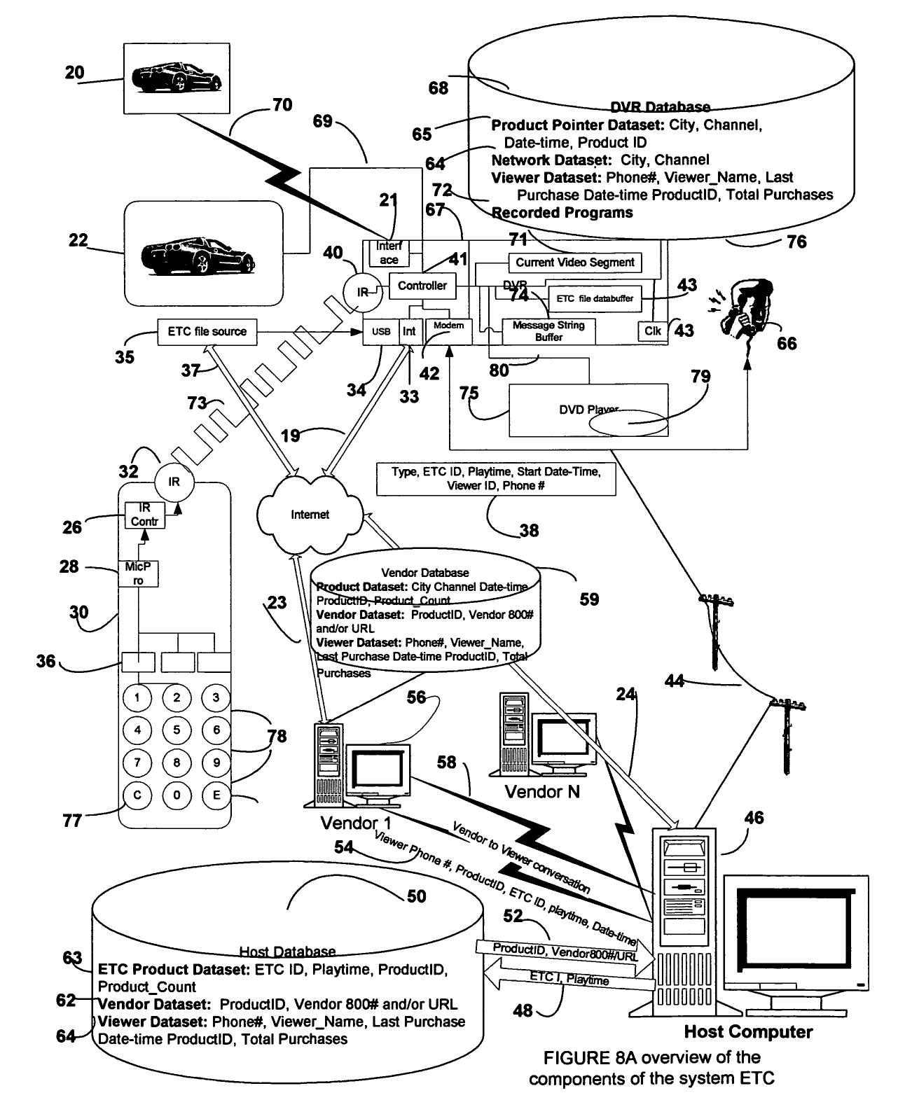

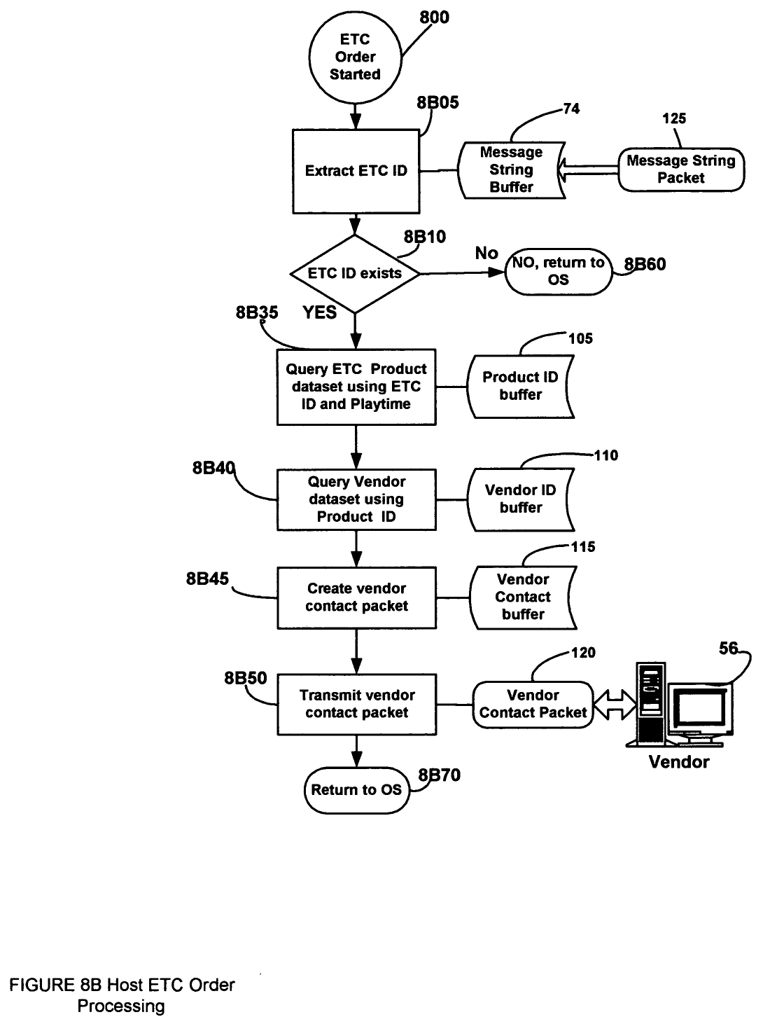

The flowchart depicts steps involved is acting on the key event and then interpreting the message type of the message string packet FIG. 5F, 125 transmitted to the host 46. The key event processor 510 determines that a message string packet has been received 529 and transfers control to the Process Packet type node 558. The message string packet contains a message type which may be one of the following: Broadcast order, external DVD order, DID ID order, ETC order, Ad number, ProductID data, Vendor ID data, City-time-channel-ProductID or other type. For example the ETC Order is detected at the if 7H27. Control is passed to the ETC order node 800. FIG. 8A overview of the components of the system ETC handling

FIG. 8A displays and overview of the system components used to handle electronically transferred content and provide the ability to process buy requests from the viewer.

DVR's will have the capability of receiving downloads of electronically transferred content (ETC) from multiple sources 35 including, but not limited to, Internet servers, personal computers, and portable playback devices such as iPOd's or USB memory devices. The ETC can be transferred via a direct link to a high-speed interface 34 such as USB or Firewire or via a link to the Internet 37 and 19 to the Internet interface 33 or other high-speed method available to the DVR. The ETC is passed via the controller 41 to recorded programs 72 and information is stored in the ETC file data buffer 43. When the viewer initiates viewing the ETC the start-time is noted. If the viewer pauses the ETC the playtime is computed. If the viewer sees a product placement or a commercial in the ETC he/she can press the buy button on the DVR remote 36. This will cause a buy signal to be sent to IR controller 26 which will generate a buy signal, which will be sent from the IR transmitter 32 as an infrared signal 73 to the IR receiver 40 on the DVR. When the buy signal is detected with the key event transmitter of the DVR the playtime is put in the message string buffer 74 with the message type, ETC ID, start date-time, Viewer ID and Phone number. The DVR makes contact with the host computer 46 via the Internet interface 33 and the links 19 and 24 or via modem 42 and the telephone system 44. The message string 38 is passed to the host computer 46. Based on the message type the host determined that the buy order is based on an ETC. The host extracts the ETC ID and the playtime and then queries the host database 50 and the ETC Product Dataset 63. The query returns the Product ID and then the Vendor ID, vendor phone number and/or Internet URL. The vendor is contacted and the product ID, ETC ID, viewer phone number are passed to the vendor, who contacts the viewer 66 and determines quantity, color, method of payment, etc.

Host ETC Order Processing (FIG. 8B)

The message string type is determined on the steps described in FIG. 7H. The ETC ID is extracted 8B05 from the message string buffer 74, which was loaded from the message string packet 125. The existence of the ETC ID is tested 8B10. If no, then return to the operating system 8B60. If yes then query the product dataset using the ETC ID and playtime 8B35. Store the productID in the buffer 105. Using the productID query the vendor dataset 8B40 and place the VendorID is the buffer 110. Next create a vendor contact packet 8B50 composed of at least, productID, VendorID, ETC ID, viewer information, and date-time. Then transmit 8B50 the vendor contact packet 125 to the selected vendor 56. Finally return to the operating system 8B70.

Packet Descriptions

The message string buffer 74 is used to assemble a data string to be sent from the DVR to the Host computer. The contents will vary depending upon the whether the source of information is a TV show, a DVD read on an integral DVD player, a DVD read on DVD player with two-way communication with the DVD, or a DVD read on a DVD player with read-only communication. The message string buffer could contain one of the following structures (but could vary to support any viewer/host/vendor requirements)

TABLE 1
DVR to Host Packet, Buy from Television
Commercial or Product Placement

| | Buy from Television |
|---|---|
| | Commercial or |
| | Product Placement Type, |
| Packet type | 2 digits |
| Viewer Name | 30 characters |
| Viewer Account Number | 15 characters |
| Viewer Phone Number | 10 digits |
| Viewer City | 40 Characters |
| Date of Capture | 8 digits (YYYYMMDD) |
| Time of Capture | 6 digits (HHMMSS, 24 h format) |
| Current Date in DVR | 8 digits (YYYYMMDD) |
| Current Time of Day | 6 digits (HHMMSS, 24 h format) |
| in DVR | |
| Channel of Capture | 3 digits (001-999) |
| CRC | 5 digits (0-65535) |

The transfer of current date and time information is used additionally to correct any discrepancies in the DVR date-time from the host's date-time. The current date and time may differ from the capture date and time if a significant time lapse is encountered from the time at which the packet is successfully transferred to the host is different from the date and time of capture. If the DVR date-time was off significantly from that of the host, then the host would be able to determine the correct product advertisement or product placement by adjusting the broadcast time. By comparing the DVR current date-time with the host date-time (which should be very accurate) the actual date-time of capture should be easily be determined.

TABLE 2
DVR to Host Packet, Buy from DVD Commercial
or Product Placement, DVD ID known

| | Buy from DVD |
|---|---|
| | Commercial or Product |
| | Placement Type, |
| Packet type | DVD ID Known, 2 digits |
| Viewer Name | 30 characters |
| Viewer Account Number | 15 characters |
| Viewer Phone Number | 10 digits |
| Viewer City | 40 Characters |
| Date of Capture | 8 digits (YYYYMMDD) |
| Time of Capture (elapsed | 6 digits (HHMMSS, 24 h format) |
| time from start) or | |
| track position | |
| information | |
| Current Date in DVR | 8 digits (YYYYMMDD) |
| Current Time of Day in | 6 digits (HHMMSS, 24 h format) |
| DVR | |
| DVD Identification String | (industry standard record) |
| CRC | 5 digits (0-65535) |

TABLE 3
DVR to Host Packet, Buy from DVD Commercial
or Product Placement, no DVD ID

| | Buy from DVD |
|---|---|
| | Commercial or |
| | Product Placement |
| | Type, DVD ID Unknown, |
| Packet type | 2 digits |
| Viewer Name | 30 characters |
| Viewer Account Number | 15 characters |
| Viewer Phone Number | 10 digits |
| Viewer City | 40 Characters |
| Start Time | 6 digits (HHMMSS, 24 h format) |
| Time of Capture | 6 digits (HHMMSS, 24 h format) |
| Current Date in DVR | 8 digits (YYYYMMDD) |
| Current Time of Day in | 6 digits (HHMMSS, 24 h format) |
| DVR | |
| DVD Pixel Buffer | (block of data representing sampled |
| | option page image data) 1000 to |
| | 2000 bytes |
| CRC | 5 digits (0-65535) |

TABLE 4
DVR to Host Packet, Buy from ETC Commercial or Product Placement

| | Buy from ETC Commercial or |
|---|---|
| | Product Placement Type, |
| | ETC ID known, |
| Packet type | 2 digits |
| Viewer Name | 30 characters |
| Viewer Account Number | 15 characters |
| Viewer Phone Number | 10 digits |
| Viewer City | 40 Characters |
| Start Time | 6 digits (HHMMSS, 24 h format) |
| Playtime | 6 digits (HHMMSS, 24 h format) |
| Current Date in DVR | 8 digits (YYYYMMDD) |
| Current Time of Day in | 6 digits (HHMMSS, 24 h format) |
| DVR | |
| ETC ID | (industry standard record) |
| CRC | 5 digits (0-65535) |

The DVD Pixel Buffer length in the table above is only an example of a potential buffer size. It could be reduced, for example, if there are enough distinctions between sections of stable screen menus to uniquely identify DVD titles adequately with smaller buffer sizes. Likewise, the buffer requirement could increase if the converse were true. Obviously, this packet or record type is not the preferred method as it is much larger and less distinct than the other packet types. The one of the modes of operation of the DVD product response system is based on using the information track 81 on the DVD to identify the DVD number.

Power-On Operation

The three modes of power-on are determined by whether a network or a major advertiser purchases the power-on service or if there is no purchaser.

Network Sponsor

If a network sponsors the system, then a power-on channel number is downloaded to each user's DVR Network Dataset 64 from the Host computer, depending upon the Viewer's city. Otherwise the dataset contains a code pointing to the Product Pointer Dataset 65, which contains date-time and the channel for power on. When the viewer powers on the TV, The DVR first looks in the Network Dataset 64. The power-on channel that is selected is the channel that serves the sponsoring network unless the Network Dataset 64 points to the Product Pointer Dataset 65.

Major Advertiser Sponsor

If a Major Advertiser sponsors the system, then a Product Pointer dataset of time and channel for the viewer's city 65 is downloaded to each user's DVR hard disk via the link from the Host Computer. When the viewer powers on the TV, the DVR checks the product pointer dataset, and if present then it becomes the source of the power-on channel. The DVR queries product pointer dataset 65 using date-time to identify the power-on channel. The power-on channel is selected that will display a show that has the sponsor's products in the commercials or has product placements. Businessweek (Dec. 13, 2004, p. 113) reported, “Procter & Gamble Co. spent $4.4 billion on advertising in the last fiscal year.” The power-on channel would allow a major advertiser to cut its ad buys in the hundreds of millions of dollars and achieve more views and more response by increasing the likelihood of a viewer seeing its ad.

No Sponsor

In the case of having no system sponsor, the Network Dataset 64 will have a “No Sponsor” code which will allow the power-on station to coincide with the station watched when the television was turned off. This is similar to normal power-on choice of stand-alone television, cable television and DVR controlled television.

TABLE 5
Definitions

| Component | Definition |
|---|---|
| Button | Key and button are used interchangeably. |
| Date-time | The date and the time of an event, usually |
| | concatenated in a computer data item. The date is |
| | stored as an integer of the days since a base date |
| | such as Jan. 01, 2001 or Jan. 01, 1980 and the time is |
| | stored as a decimal fraction of 24 hours. When |
| | displayed the date-time is shown as |
| | YYYY/MM/DD hh:mm:ss. |
| Designated buy button | A button on the remote which has no function during |
| | a TV show or playback of a show that is used to |
| | indicate a buy or contact decision by the viewer |
| Designated capture | A button on the remote, which has no function during |
| button | a TV, show, playback of a show or when no show is |
| | being watched that is used to indicate a desire by the |
| | viewer to capture numbers on the key pad of the |
| | remote. This button is not the designated buy button. |
| DVD | Digital video disk or digital versatile disk or DVD |
| DVR | Digital video recorder including a microprocessor |
| | interfaces for TV signal input, telephone and/or |
| | Internet, and a hard disk or other form of memory. |
| | In the present invention DVR can include electronic |
| | entertainment centers which recorder includes a |
| | microprocessor, interfaces for TV signal input, |
| | telephone and/or Internet, and a hard disk or other |
| | form of memory and the software used to store, |
| | manipulate and display content. |
| Embedded commercials | TV commercials included in a TV show between the |
| | entertainment segments |
| ETC | Electronically transferred content, including but not |
| | limited to entertainment, commercials, news, and |
| | music. The sources include, but are not limited to, |
| | Internet servers, personal computers, and portable |
| | playback devices such as iPOd's or USB memory devices. |
| Host | A centralized computer maintaining multiple |
| | databases including, but not limited to time-channel- |
| | city-ProductID, ProductID-VendorID, VendorID, |
| | vendor contact, viewer information, DVD-playtime- |
| | productID, ETC-playtime-productID. The host can be |
| | the provider of the DVR or can be an independent third party. |
| Infomercial | Long form TV commercials that last for the duration of |
| | the TV show |
| Infrared linked hand-held | A hand-held device that transmits coded signals via |
| remote | the illumination of an infrared light to the receiving |
| | device which has an infrared detector |
| Interface for a television | Input means to allow receipt of television broadcast |
| signal input | |
| Interface to telephone | A link between the microprocessor and a telephone |
| lines | line that can dial and pass signal information, the |
| | device is typically a modem |
| Internet link | Input/output means to allow receipt and transmission |
| | of Internet protocol messages |
| Key | Key and button are used interchangeably. |
| Memory means to | Including at least a hard disk memory and capability |
| identify a power-on | to store and query the data stored on the hard disk to |
| channel based on | determine if there is a network sponsor |
| network sponsor | |
| Memory means to | Including at least a hard disk memory and capability |
| identify products based | to query the data stored on the hard disk to determine |
| on date-time and | a product identification based on date-time and |
| channel based on | channel of the record |
| product sponsor | |
| Memory means to keep | Including at least hard disk memory and capability to |
| track of the viewer and | store and query the data stored on the hard disk to |
| the viewer's transactions | maintain and report viewer data, at least name and |
| | address and to retrieve said viewer data |
| Non-broadcast formats | Including but not limited to downloaded shows and |
| | movies transferred via video on demand, internet |
| | transfers using streaming and peer transfers such as |
| | bit torrent |
| Product placement | Displays of products embedded in TV shows such as |
| | an actor drinking a can of Coke |
| Set-top box for storing | Electronic device with a hard disk and input of a |
| and forwarding television | television broadcast signal. Said broadcast can be |
| shows with and product | stored on the hard disk. Later the option of the |
| placements | viewer the stored broadcast can be fed to a television |
| | monitor for viewing |
| Television shows | Broadcast entertainment |
| TV commercials | Video presentations showing products or services |
| | placed between segments of TV shows. |
| Vector | There are numerous definitions. In the context of the |
| | present invention a vector is a file or sub portion of a |
| | file containing a series of numbers such as pixel |
| | values or pixel x, y locations |
| Viewer/customers | Home users of the digital video recorder who click the |
| | Buy button on the hand-held remote, in response to |
| | an TV commercial or product placement and are |
| | connected to the vendor computer via the host |
| | computer |
| Viewer response | Contact from the viewer to the vendor stimulated by |
| | the commercial or product placement |
| ++ | Increment by adding 1 |
| = | In an if statement: is equal to |
| = | In a assignment statement: is replaced by |

What is claimed is:

1. A method for remote buying of a product by a viewer or contacting a vendor in response to viewing of an advertisement of the product on a television broadcast comprising:
broadcasting a televised advertisement of the product or service at a known date, a time, a channel and city;
providing for the said advertisement a unique advertisement identifier representative of the broadcast date, the time, the channel and the city of the original advertisement and a product identifier to be stored in a database available to a host computer by the advertiser or a third party;
providing software to a multiplicity of digital video recorders (digital video recorders) and related remote controllers adapted to remotely control pre-designated operations of the digital video recorder;
recording on the digital video recorder the said advertisement identifier, a viewer identifier including the viewer's city and phone number, and time elapsed between the time of the original advertisement broadcast and when the original advertisement is played on the digital video recorder;
actuating a designated buy button on the remote controller to generate a first signal indicative of viewer interest in buying the product and transmitting from the remote controller to the digital video recorder that first signal;
upon receiving from the remote controller the first signal, generating in the digital video recorder a second signal representative of the time elapsed, the broadcast date, the time, the channel and the city of the advertisement broadcast and the viewer identifier;
transmitting the second signal to a host computer;
said host computer determining the product advertised from information provided in the third signal and associating a vendor of the product advertised with the second signal; and
contacting the vendor and providing to the vendor information about the product advertised and information about the viewer.

2. A method for remote buying of a product by a viewer or contacting a vendor in response to viewing of a product placement on a television broadcast comprising:
broadcasting a televised product placement of the product at a date, a time, a channel and city;
providing for the product placement an identifier representative of the broadcast date, the time, the channel and the city of the original product placement;
providing software to a multiplicity of digital video recorders and a remote controller adapted to remotely control pre-designated operations of the digital video recorder;
recording on the digital video recorder the said advertisement identifier, a viewer identifier including the viewer's city and phone number, and time elapsed between the time of the original advertisement broadcast and when the original product placement is played on the digital video recorder;
actuating a designated buy button on the remote controller to generate a first signal indicative of viewer interest in buying the product and transmitting from the remote controller to the digital video recorder that first signal;
upon receiving from the remote controller the first signal, generating in the digital video recorder a second signal representative of the time elapsed, the broadcast date, the time, the channel and the city of the product placement broadcast and the viewer identifier;
transmitting the second signal to a host computer;
transmitting the third signal to a host computer;
said host computer determining the product placement from information provided in the third signal and associating a vendor of the product placement with the second signal; and
contacting the vendor and providing to the vendor information product placement and about the viewer.

3. A plurality of vendor computers, where each said vendor computer comprises at least:
a communication method for transfer of data between computers, a memory means to store and retrieve viewer information, a memory means to store and retrieve product sales information, a method for billing viewers, a means to communicate with viewers, a means to communicate commercial schedules to the host computer, a means to communicate product identifications to the host computer;
whereas the vendor computers are capable of at least receiving product or service inquiry s and viewer information from the host computer, communicating to the viewer, communicating commercial schedules to the host computer, and communicating product identifications to the host computer;
whereas viewers will be able to contact vendors by pressing the designated buy button on the digital video recorder remote controller during a television advertisement or product placement, the broadcast date, time, channel and city in which viewed will uniquely identify the product and the host computer will have the information necessary to identify the product desired by the viewer and the vendors who can provide the product to the viewer.

4. a method to select a channel when power-button is first actuated on the digital video recorder (the power-on channel) depending on whether a network pays for the system power-on service comprising:
a digital video recorder which includes an interface to a television signal source, an interface to a television display, a communication method for transfer of data between the digital video recorder and a host computer, a memory means to store and retrieve power-on station channel information as provided from the host computer, an interface to a remote control, a remote control which includes an interface to the digital video recorder, a keyset, including at least a power button;
whereas the method facilitates and increases viewership of television programs containing advertisements and/or product placements broadcast by a network by selecting the channel of said television network in each city when the viewer presses the power button on the remote controller of the digital video recorder or on the digital video recorder and/or at designated times determined by information provided by the host computer corresponding to channels and cities corresponding to networks that have contracted with the host to provide this service.

5. A communication and data storage method for transfer of data between computers comprising:
a memory means to store and retrieve television program schedules for a plurality of cities or areas, a memory means to store and query a table of commercials by city, broadcast date-time and channel and product identification, a memory means to store and query a table of product identifications and vendor information;
whereas the host computer is capable of at least receiving a product or service inquiry message from the viewer's digital video recorder; identifying the product desired, based upon the city, broadcast date, time and channel; identifying the vendor of the product, transmitting the product or service inquiry and viewer information to the appropriate vendor's computer, keeping records of the viewers, the transactions, the program schedules, and the commercial schedules of sponsors.

6. A method of a plurality of vendor computers, where each said vendor computer comprises at least:
a communication method for transfer of data between computers, a memory means to store and retrieve viewer/customer information, a memory means to store and retrieve product sales information, a method for billing customers, a means to communicate with viewers, a means to communicate commercial schedules to the host computer, a means to communicate product identifications to the host computer;
whereas the vendor computers are capable of at least receiving product or service inquiries and viewer information, communicating via the host or through other means to the viewer, communicating commercial schedules to the host computer, and communicating product identifications to the host computer;
whereas the method and system facilitates the contact between viewers and the sponsoring major advertiser by presenting the television shows containing commercials and product placements of the said sponsoring major advertiser, and whereas such contact will be facilitated by the viewer pressing the designated buy button on the digital video recorder remote controller during a television commercial or product placement.

7. A method to determine the identity of a digital video disk (DVD) and the product placement in that DVD comprising:
a host computer and database containing a table of records containing pixel strings versus DVD identities and product placements in those DVDs and their corresponding elapsed play time of the DVD, and vendors associated with those product placements;
a DVD player connected to the said digital video recorder providing a television signal, an interface to a television display for viewing the DVD television signal through the digital video recorder, a hand-held remote controller having an interface to the DVD player and to the digital video recorder and which includes a keyboard, memory in the digital video recorder for storing lines of pixels contained in the television signal, a memory means to extract a sample of pixels from a from a video frame, a process to compare samples of pixels;
whereas the digital video recorder can assemble a signal containing the viewer information, play time and the captured pixels, transmitting the signal to the host computer which then compares the captured pixels to its database to determine the title of the DVD, then using the play time into the video said host computer determining the product placement or advertisement, using this information to determine the vendor and facilitating the communication between the vendor and the viewer.

8. A method to facilitate the purchase of items advertised or presented as product placements on a DVD disk via the digital video recorder remote controller and the digital video recorder comprising:
a digital video recorder capable of determining the identification of the DVD disk, its play time within the digital video recorder, a digital video recorder remote having a keyboard and a designated buy key;
when said designated buy key of the digital video recorder remote is actuated in response to a desired purchase of a displayed product the digital video recorder is able to assemble a signal containing the DVD identification information, the play time, the viewer information;
whereas upon completion of the assembly of said signal the digital video recorder is capable of transferring this signal to the host computer and said host computer facilitating the communication between the vendor of the product presented to the viewer on the DVD and the viewer.

9. A method to facilitate user response to print advertisements comprising:
providing print advertisements that contain an advertisement number uniquely associated with the product advertised;
a digital video recorder and hand-held remote controller for said digital video recorder;
whereas the viewer may press the designated capture button and then press number keys on the remote controller of the digital video recorder corresponding to the print advertisement number and then press the designated buy button;
whereupon the digital video recorder will assemble a signal containing the print advertisement number and viewer information and then transfer that signal to the host computer;
the said host computer determining the product advertised from information provided in the signal and associating a vendor of the product advertised with the signal; and
contacting the vendor and providing to the vendor information about the product and the viewer.

10. A method to facilitate purchases, upgrades and/or maintenance of household, commercial or industrial equipment comprising:
a digital video recorder and hand-held remote controller for said digital video recorder;
whereas the viewer may press the designated capture button and then press number keys on the remote controller of the digital video recorder corresponding to numbers that appear in printed service items such as owners or service manuals, from parts or assemblies parts, or assemblies for the purchase, upgrade and/or maintenance of household, commercial or industrial equipment and sending this signal to the digital video recorder;
upon receiving from the remote controller the signal, generating in the digital video recorder a second signal representative of the printed service item and the viewer identifier;
transmitting the second signal to a host computer;
the said host computer determining the product or service item from information provided in the second signal and associating a vendor of the product or service associated with the second signal; and
contacting the vendor and providing to the vendor information about the product and the viewer.

11. A method to facilitate the purchase of items advertised or presented as product placements on an electronically transferred or downloaded entertainment program or content via the digital video recorder remote and digital video recorder or entertainment center or content hub comprising:
a digital video recorder and hand-held remote controller for said digital video recorder;
electronically transferred content containing an advertisement of the product or product placement at an elapsed time into the electronically transferred content;
providing for the original advertisement an original advertisement identifier representative of the elapsed time into the entertainment program and an electronically transferred content identifier;
when the designated buy key of the remote is actuated in response to a desired purchase of a displayed product, the remote transmits the buy signal to the digital video recorder;
said digital video recorder upon receiving said signal is able to assemble a second signal containing the entertainment program identification, the product identification information, and the viewer information;
transmitting the second signal to a host computer;
the said host computer determining the product or service item from information provided in the second signal and associating a vendor of the product or service associated with the second signal; and
the said host computer contacting the vendor and providing to the vendor information about the product and the viewer.

12. a method to select a channel when power is first actuated on the digital video recorder (the power-on channel) depending on the date-time range and whether a sponsor pays for the system power-on service corresponding to the date-time range comprising:
a digital video recorder which includes an interface to a television signal source, an interface to a television display, a communication method for transfer of data between the digital video recorder and a host computer, a memory means to store and retrieve date-time ranges and power-on station channels information as provided from the host computer, an interface to a remote control, a remote control which includes an interface to the digital video recorder, a keyset, including at least a power button;
whereas the method facilitates and increases viewership of television programs containing advertisements and/or product placements of a sponsor by selecting the channel of said television programs when the viewer presses the power button on the remote controller of the digital video recorder or on the digital video recorder and/or at designated times determined by information provided by the host computer corresponding to channels and times when sponsors have contracted with the host to provide this service to the sponsors.

13. a method to select a channel when power-button is first actuated on the digital video recorder (the power-on channel) depending on whether a network pays for the system power-on service during a date-time range comprising:
a digital video recorder which includes an interface to a television signal source, an interface to a television display, a communication method for transfer of data between the digital video recorder and a host computer, a memory means to store and retrieve power-on station channel and date-time ranges information as provided from the host computer, an interface to a remote control, a remote control which includes an interface to the digital video recorder, a keyset, including at least a power button;
whereas the method facilitates and increases viewership of television programs containing advertisements and/or product placements broadcast by one or more networks by depending on date-time and city, selecting the channel of said television network in each city when the viewer presses the power button on the remote controller of the digital video recorder or on the digital video recorder and/or at designated times determined by information provided by the host computer corresponding to channels and cities corresponding to networks that have contracted with the host to provide this service.
